(19) United States
(12) Patent Application Publication
(10) Pub. No.: US 2025/0047649 A1
(43) Pub. Date: Feb. 6, 2025

(54) METHODS, DEVICES AND SYSTEMS FOR TRUSTWORTHINESS CERTIFICATION OF INFERENCE REQUESTS AND INFERENCE RESPONSES

(71) Applicant: Huawei Technologies Co., Ltd., Shenzhen (CN)

(72) Inventors: Yiqun Ge, Kanata (CA); Wuxian Shi, Kanata (CA); Wen Tong, Ottawa (CA)

(21) Appl. No.: 18/822,799

(22) Filed: Sep. 3, 2024

Related U.S. Application Data
(63) Continuation of application No. PCT/CN2022/079010, filed on Mar. 3, 2022.

(51) Int. Cl. H04L 9/40; G06N 3/045; G06N 5/04

(52) U.S. Cl. CPC H04L 63/0428; G06N 3/045; G06N 5/04

(57) ABSTRACT

Some embodiments of the present disclosure provide certification for the handling of an inference request that is transmitted to a DNN hosted on a remote computing system. Output data, received responsive to the inference request, may be certified as being appropriately generated by the DNN, rather than being tampered with or generated by a malicious DNN. Output data from the DNN may be also certified as appropriately corresponding to input data included in the inference request. Linear block coding may be used on transmissions to guard against eavesdropping and tampering. Through the use of a certification DNN, a degree of comfort may be gained that given output data appropriately corresponds to input data included in a given inference request. Furthermore, known patterns inherent in DNN outputs may be used to establish the integrity of received out

### CROSS-REFERENCE TO RELATED APPLICATIONS

This application is a continuation of International Application No. PCT/CN2022/079010, filed on Mar. 3, 2022, which is hereby incorporated by reference in its entirety.

### TECHNICAL FIELD

The present disclosure relates, generally, to methods, devices, and systems for certification of trustworthiness of inference requests and inference responses generated by a deep neural network implemented on a computing system, such as a cloud computing system.

### BACKGROUND

Deep neural networks (DNNs) are known for their complexity and their intense use of computing resources. A DNN, which approximates a non-linear function, is trained to perform a particular task, such as a computer vision task, a natural language processing task, or a speech processing task. A DNN receives input data in the form of a vector or tensor and generates inference data (e.g. a prediction) based on the input data. DNNs are generally hosted on remote computing systems having significant amounts of computing resources (e.g. memory and processing resources) due to their size and complexity. Hosting DNNs on remote computing systems, such as cloud computing systems, enables a third party organization, such as a cloud computing provider, to create and manage DNNs which perform particular tasks, and to provide access to the DNNs to users of the DNNs via the Internet to provide input data for a particular DNN to perform inference for a particular task. To access a DNN hosted on a remote computing system, a client computing device (“client device”) transmits, to the remote computing system hosting a DNN is implemented, over a communication network, an inference request that include input data for the DNN that includes input data and receives, from the remote computing system, over the communication network, an inference response that includes inference data generated by the DNN based on the input data.

The transmission, over wireless and wired network connections, of an inference requests from a client device to a remote computing system on which a DNN is implemented and the reception, over the same wireless and wired network connections, of the inference response generated by the DNN opens up the inference requests and inference responses to malicious attacks, such as eavesdropping and tampering.

### SUMMARY

The present disclosure provide methods, devices, and systems for trustworthiness certification of input data included in an inference request that is to be transmitted, by a client device, via networks of a communication system, to a remote computing system hosting a DNN, such as a cloud computing system. Inference data, included in an inference response that is transmitted by the remote computing system to the client device, may be certified as being appropriately received from the client device and generated by the DNN, rather than having been tampered with or generated by a malicious DNN. Inference data included in the inference response may be also certified as appropriately corresponding to input data included in the inference request.

An unfortunate side effect of hosting a DNN on a computing system that is remote from the client device is that transmissions between a client device and the computing system are opened up to a wide variety of malicious attacks. Malicious attacks may occur as eavesdropping or tampering with transmissions that contain the inference request and the inference response as those transmissions are received and forwarded by various network entities in a communication system. The transmissions may contain the inference request, including input data, or a corresponding inference response, including inference data. Additionally, malicious attacks may be based at the computing system hosting the DNN. Such malicious attacks may involve the DNN, perhaps to conserve computing resources, providing a response including inference data that does not correspond to input data included in the request. Accordingly, the degree to which inference data corresponds to input data may be called into question.

Aspects of the present application relate to the use of linear block coding of input data included in an inference request generated by an application running on an electronic device to guard against eavesdropping on, and tampering with, the input data. Through the use of a certification DNN, a degree of comfort may be gained that given inference response inference data appropriately corresponds to given input data. Furthermore, known patterns inherent in the output data generated by the DNN may be used to establish the integrity of the output data.

According to an aspect of the present disclosure, there is provided a method. The method includes encoding, using a linear block encoder, an input data vector, thereby obtaining an encoded input vector, transmitting an inference request, the inference request including the encoded input vector and receiving an inference response.

According to another aspect of the present disclosure, there is provided a method of handling an inference request. The method includes receiving an inference request, the inference request including an input data vector, transmitting the inference request, encoding, using a linear block encoder, the input data vector to, thereby, obtain an actual encoded input vector, receiving an inference response, the inference response including an output data vector, obtaining, on the basis of the output data vector, an estimated encoded input vector, obtaining a trustworthiness score representative of a comparison of the estimated encoded input vector to the actual encoded input vector and, responsive to determining that the trustworthiness score exceeds a threshold, transmitting the output data vector.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices (EDs) and multiple example radio access network (RAN) nodes along with various networks;

FIG. 2 illustrates, in a block diagram, the communication system of FIG. 1, the communication system includes multiple example EDs, an example terrestrial RAN node and an example non-terrestrial RAN node along with various networks;

FIG. 3 illustrates, as a block diagram, elements of an example ED of FIG. 2, elements of an example terrestrial RAN node of FIG. 2 and elements of an example non-terrestrial RAN node of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates, in a block diagram a typical scenario wherein an ED sends a request to a DNN-on-Cloud via a RAN node;

FIG. 7A illustrates components of an ED responsible, in part, for processing an inference request, in accordance with aspects of the present application;

FIG. 7B illustrates components of an ED responsible, in part, for processing an inference response, in accordance with aspects of the present application;

FIG. 8A illustrates components of a computing system and a RAN node responsible, in part, for processing an inference response, in accordance with aspects of the present application;

FIG. 8B illustrates components of a computing system and a RAN node responsible, in part, for processing an inference request, in accordance with aspects of the present application;

FIG. 9 illustrates a scenario similar to the scenario of FIG. 6, wherein the ED is a specific ED;

FIG. 10 illustrates example steps in a method of obtaining certified inference responses from the perspective of the ED of FIG. 9, in accordance with aspects of the present application;

FIG. 11 illustrates example steps in a method of handling an inference request from the perspective of the RAN node of FIG. 9, in accordance with aspects of the present application;

FIG. 12 illustrates further example steps in a method of handling an inference request from the perspective of the RAN node of FIG. 9, in accordance with aspects of the present application;

FIG. 13 illustrates further example steps in a method of obtaining certified inference responses from the perspective of the ED of FIG. 9, in accordance with aspects of the present application;

FIG. 14 illustrates further example steps in a method of handling an inference request from the perspective of the RAN node of FIG. 9, in accordance with aspects of the present application;

FIG. 15 illustrates example steps in a method of handling an inference request from the perspective of the RAN node of FIG. 9, where the RAN node is not provided access to a linear block encoding matrix, in accordance with aspects of the present application;

FIG. 16 illustrates an overview of certification as example steps in a method carried out by the RAN node of FIG. 9, in accordance with aspects of the present application;

FIG. 17 illustrates example steps in a method of carrying out, at the RAN node of FIG. 9, a certification protocol, in accordance with aspects of the present application;

FIG. 18 illustrates example steps in a method of carrying out an intra-group consistence check as part of the method illustrated in FIG. 17, in accordance with aspects of the present application;

FIG. 19 illustrates example steps in a method of carrying out an inter-group consistence check as part of the method illustrated in FIG. 17, in accordance with aspects of the present application;

FIG. 20 illustrates example steps in a method, carried out at the ED of FIG. 9, of receiving an encoded certified inference response vector, in accordance with aspects of the present application; and

FIG. 21 illustrate example steps in a method carried out at the ED of FIG. 9, where the method is associated with coded input data vectors and encoded inference response vector, in accordance with aspects of the present application.

### DETAILED DESCRIPTION OF THE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

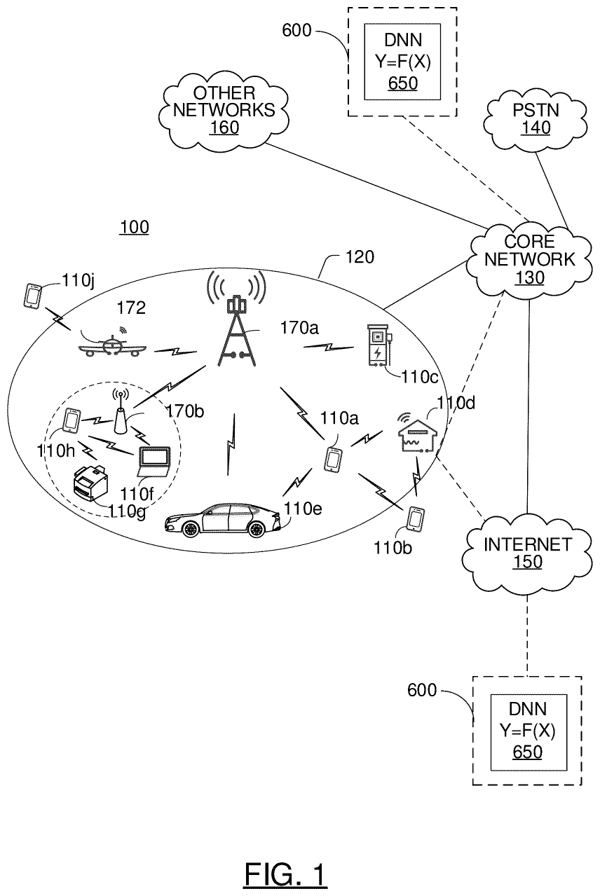

Referring to FIG. 1, a simplified schematic illustration of an example communication system 100 is shown. The communication system 100 comprises several networks, including a radio access network 120, a core network 130, a public switched telephone network (PSTN) 140, the internet 150, other networks 160, and a remote computing system 600 that hosts a DNN 650.

The radio access network (RAN) 120 may be a next generation (e.g., sixth generation, “6G,” or later) radio access network, or a legacy (e.g., 5G, 4G, 3G or 2G) radio access network. One or more electronic communication devices (ED) 110a, 110b, 110c, 110d, 110e, 110f, 110g, 110h, 110i, 110j (generally referred to as ED 110 and collectively referred to as EDs 110) may be connected to one another or connected to one or more radio access network (RAN) nodes 170a, 170b of the RAN 120 (generally referred to as RAN nodes 170 and collectively referred to as RAN nodes 170). The core network 130 may be dependent or independent of the radio access technology used in the communication system 100.

The remote computing system 600 (“computing system 600”) in the communication system 100 shown in FIG. 1 may be directly or indirectly connected to the core network 130. The computing system 600 include multiple powerful computing resources, including central processing units, hardware accelerators, graphic processing units, and memory, that are used to train the DNN 650 hosted thereon. The remote computing system 600 may be a cloud computing system (“cloud”) that hosts multiple different DNNs trained for different tasks, including the DNN 650. The DNN 650 hosted on the computing system 600 may receive multiple inference requests from an ED 110 or multiple inference requests from different EDs 100 and may perform multiple different inferences simultaneously. For example, when an application running on an ED 110 generates an inference job that includes one or more inference requests for DNN 650, the ED 110 (“the requesting ED 110”) transmits the inference job for DNN 650 in a wireless transmission to a RAN node 170, and the RAN node 170 processes the wireless transmission to obtain the inference request and transmits the inference request to the computing system 600 that hosts the DNN 650 via the core network 130 using a wired and/or wireless transmission. The computing system 600, upon receipt of the transmission that includes the inference job for the DNN 650, registers the inference job with the DNN 650. The computing system 600 invokes the DNN 650 hosted thereon to perform the requested inference job. After that, the ED 110 sends the inference requests for the DNN 650 included in the inference job to the computing system 600 that hosts the DNN 650 via RAN node 170 and the core network 130 as described in further detail below. As described in further detail below, an inference request contains input data of an inference request, a control header that includes an indication of the DNN 650 the inference request is for. Once the inference request is received by the computing system 600, the cloud computing system 600 provides the input data of the inference request to the DNN 650 and the DNN 650 performs inference that yields inference data. The DNN 650 then generates an inference response and provides the inference response to the computing system 600. The inference response includes the inference data generated and provided by the DNN 650 and other result-related parameters to the inference data. The computing system 600 hosting the DNN 650 sends the inference response to the ED 110 via the core network 130 and the RAN node 170.

In some embodiments, the computing system 600 that hosts the DNN 650 may be indirectly connected to core network 130 via Internet 150. The inference requests and inference responses transmitted between an ED and the computing system 600 may be encapsulated in TCP/IP packets in this embodiment.

A RAN node 170 may be equipped with powerful computing resources. Alternatively a RAN node 170 or may be connected to a computing system that include powerful computing resources by wireless connections, such as radio connections, or wired connections. RAN node 170 that is equipped with powerful computing resources or a computing system that is located near a RAN node 170 and connected to the RAN node 170 is generally referred to as edge computing system.

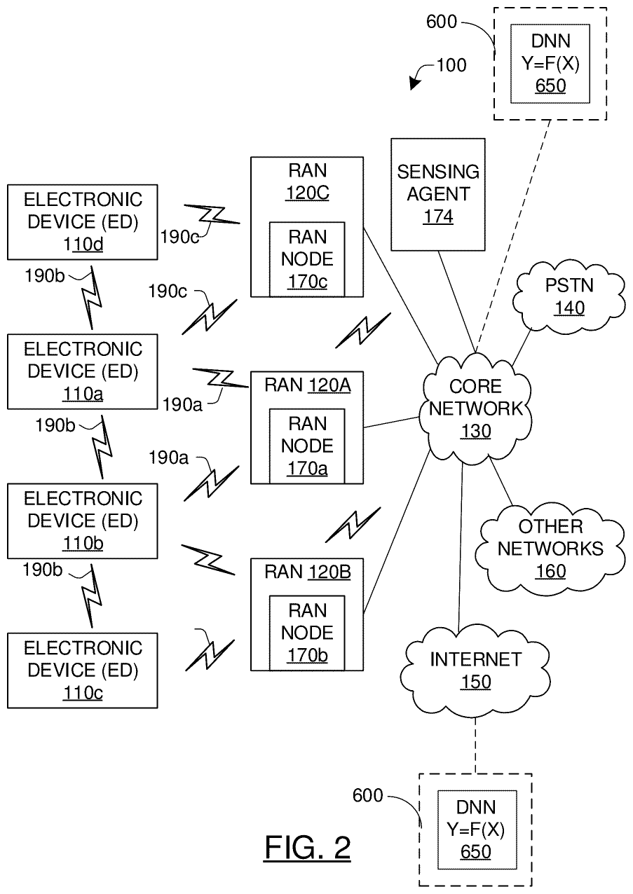

FIG. 2 illustrates examples of various networks and EDs of the example communication system 100 shown in FIG. 1. In general, the communication system 100 enables multiple wireless or wired elements (e.g. EDs 110, RANS 120, core network 130) to communicate data and other content with each other. The communication system 100 may enable communication of data and other content, such as voice, video, and/or text, via, for example, broadcast, multicast and unicast, transmissions. The communication system 100 may operate by sharing resources, such as carrier spectrum bandwidth, between its wireless elements (e.g. EDs 110 and RANs 120) for wireless communications. The communication system 100 may include a terrestrial communication network and/or a non-terrestrial communication network. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication network and a non-terrestrial communication network. For example, integrating a non-terrestrial communication network (or components thereof) into a terrestrial communication network can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks. RANs 120 and the core network 130 may be a non-terrestrial communication network, a non-terrestrial communication network, or a heterogeneous communication network.

The terrestrial communication network and the non-terrestrial communication network could be considered sub-networks of a RAN 120 of the communication system 100. In the example shown in FIG. 2, the communication system 100 includes electronic devices (ED) 110a, 110b, 110c, 110d, radio access networks (RANs) 120a, 120b, 120c, a core network 130, a public switched telephone network (PSTN) 140, the Internet 150 and other networks 160. The RANs 120a, 120b are terrestrial communication networks and include RAN nodes 170a, 170b, which may be a base station, an eNB, a gNB, or transmit and receive point (TRP). The RAN network 120c is a non-terrestrial communication network and includes one or more RAN nodes 172, which may be generically referred to as a non-terrestrial transmit and receive point (NT-TRP) 172.

Any ED 110 may be alternatively or additionally configured to interface, access, or communicate with any RAN node 170, the Internet 150, the core network 130, the PSTN 140, the other networks 160, or any combination of the preceding. In some examples, the ED 110a may communicate an uplink and/or downlink transmission over a terrestrial air interface 190a with RAN node 170a, which may be T-TRP. In some examples, the EDs 110a, 110b, 110c and 110d may also communicate directly with one another via one or more sidelink air interfaces 190b. In some examples, the ED 110d may communicate an uplink and/or downlink transmission with a RAN node 170c) of the RAN 120c over a non-terrestrial air interface 190c, which may be a NT-TRP.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple RAN nodes 170 via a wireless link or simply a link. For some examples, the link is a dedicated connection for unicast transmission, a connection for broadcast transmission, or a connection between a group of EDs 110 and one or multiple RAN nodes 170 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

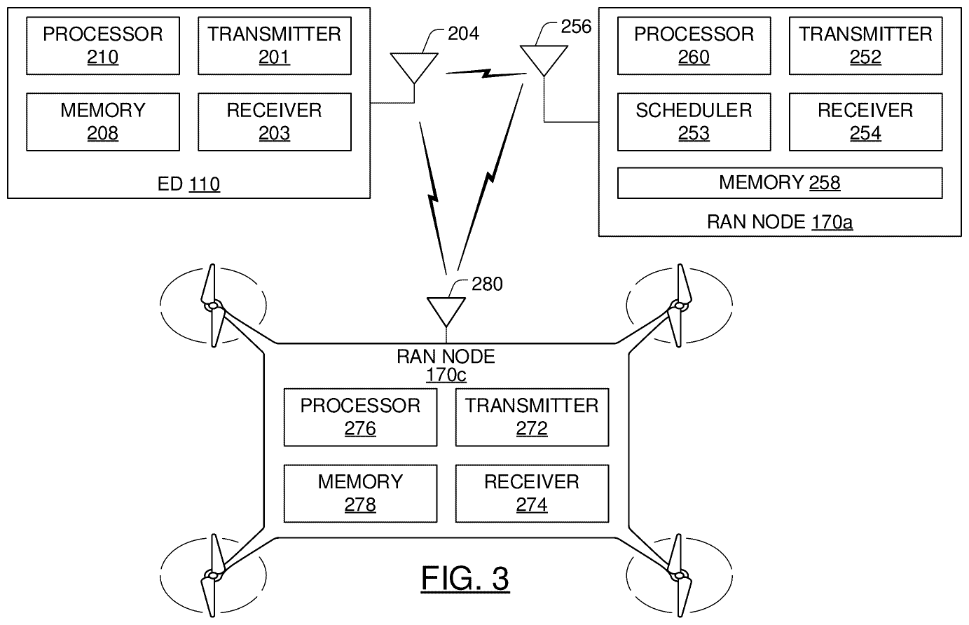

FIG. 3 illustrates block diagrams of an ED 110, RAN node 170A that is a NT-TRP and RAN node 170B that is a T-TRP. Other EDs 110 and RAN nodes 170 of the communication system 100 may be similar to the ED 110 and RAN nodes 170A, 170B shown in FIG. 3. The ED 110 is used by persons, objects, machines, etc. and may connect to a network, such as RAN 120, or to another ED 110. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 is any suitable electronic device configured for wireless communication with wireless networks, such as a RAN 120 and/or a WiFi networks, and may be referred to as a user equipment (UE) or user device. The ED 110 may be any type of end user device, such as an electronic device, a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IOT device, an industrial device, or apparatus (e.g., communication module, modem, or chip) in the forgoing devices, among other possibilities. Future generation EDs 110 may be referred to using other terms. Each ED 110 connected to the RAN node 170, which is T-TRP and/or RAN node 170c, which is a NT-TRP 170c can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated in FIG. 3. One, some, or all of the antennas 204 may, alternatively, be panels. The transmitter 201 and the receiver 203 may be integrated into a single device, generally referred a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes a processor 210 for performing operations including those operations related to preparing uplink transmissions to RAN node 170c, which is a NT-TRP, and/or the RAN nodes 170a, 170b which are T-TRPs, and those operations related to processing downlink transmissions received from RAN node 170c and/or RAN nodes 170a, 170b, and those operations related to processing sidelink transmissions to and from another ED 110. Processing operations related to preparing uplink transmissions may include operations such as encoding, modulating, transmit beamforming and generating symbols for the uplink transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the RAN node 170c and/or by RAN nodes 170a, 170b. In some embodiments, the processor 210 implements the transmit beamforming and/or the receive beamforming based on the indication of beam direction, e.g., beam angle information (BAI), received from RAN node 170a. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from RAN node 170c and/or from RAN nodes 170a, 170b.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

A RAN node 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a terrestrial transmit and receive point (TRP), a non-terrestrial transmit and receive point (NT-TRP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. Referring to FIG. 3, the RAN node 170a, which is a T-TRP, may be a macro BS, a pico BS, a relay node, a donor node, or the like, or combinations thereof. A RAN node 170a may refer to the forgoing devices or refer to apparatus (e.g., a communication module, a modem or a chip) in the forgoing devices.

In some embodiments, the parts of a RAN node 170 may be distributed. For example, some of the modules of a RAN node 170 may be located remote from the equipment that houses antennas 256 for the RAN node 170, and may be coupled to the equipment that houses antennas 256 over a communication link (not shown) sometimes known as front haul, such as common public radio interface (CPRI). Therefore, in some embodiments, the term RAN node may also refer to modules on the network side that perform processing operations, such as determining the location of the ED 110, resource allocation (scheduling), message generation, and encoding/decoding, and that are not necessarily part of the equipment that houses antennas 256 of the RAN node 170. The modules may also be coupled to other RAN nodes. In some embodiments, RAN node 170 may comprise a plurality of TRPs (e.g. N-TRPs and/or T-TRPs) that are operating together to serve the ED 110, e.g., through the use of coordinated multipoint transmissions.

As illustrated in FIG. 3, RAN node 170a includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. RAN node 170a further includes a processor 260 for performing operations including those related to: preparing a transmission for downlink transmission to the ED 110; processing an uplink transmission received from the ED 110; preparing a transmission for backhaul transmission to RAN node 170c; and processing a transmission received over backhaul from RAN node 170c. Processing operations related to preparing a transmission for downlink or backhaul transmission may include operations such as encoding, modulating, precoding (e.g., multiple input multiple output (MIMO) precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the RAN node 170c, etc. In some embodiments, the processor 260 may generate signaling, e.g., to configure one or more parameters of the ED 110 and/or one or more parameters of the RAN node 170c. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, RAN node 170a. The scheduler 253 may schedule uplink, downlink and/or backhaul transmissions, including issuing scheduling grants and/or configuring scheduling-free (“configured grant”) resources. The RAN node 170a, which is a T-TRP, further includes a memory 258 for storing information and data. The memory 258 stores instructions and data used, generated, or collected by the RAN node 170a. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the RAN node 170c, which is a NT-TRP in FIG. 3, is illustrated as implemented in a drone only as an example, the RAN node 170c may be implemented in any suitable non-terrestrial device. Also, a NT-TRP may be known by other names in some implementations, such as a non-terrestrial node, a non-terrestrial network device, or a non-terrestrial base station. The RAN node 170c, which is a NT-TRP, includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The RAN node 170c, which is a NT-TRP, further includes a processor 276 for performing operations including those related to: preparing a transmission for downlink transmission to the ED 110; processing an uplink transmission received from the ED 110; preparing a transmission for backhaul transmission to RAN node 170a; and processing a transmission received over backhaul from the RAN node 170a Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the RAN node 170a. In some embodiments, the processor 276 may generate signaling, e.g., to configure one or more parameters of the ED 110. In some embodiments, the RAN node 170c implements physical layer processing but does not implement higher layer functions such as functions at the medium access control (MAC) or radio link control (RLC) layer. As this is only an example, more generally, the RAN node 170c may implement higher layer functions in addition to physical layer processing.

The RAN node 170c further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the RAN node 170c may include a plurality of NT-TRPs that are operating together to serve the ED 110, e.g., through coordinated multipoint transmissions.

A RAN node 170, such as RAN node 170a or the RAN node 170c, and/or the ED 110 may include other components, but these have been omitted for the sake of clarity.

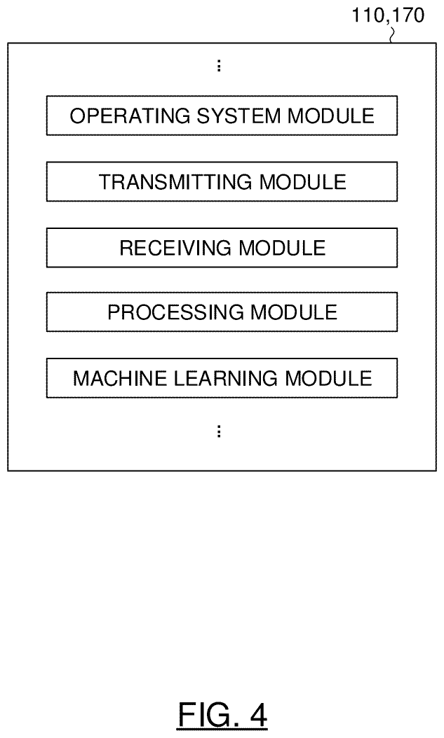

One or more steps of the embodiment methods for trustworthiness certification of inference requests and inference responses described herein may be performed by units or modules of an ED 110 or a RAN node 170. FIG. 4 illustrates units or modules in ED 110, RAN node 170. For example, a wireless signal, such as a radio frequency signal, may be transmitted by a transmitting unit or by a transmitting module of the ED 110, RAN node. The transmitting unit or module may perform source encoding and channel encoding at the media access control (MAC) layer and physical layers as is known to a person skilled in the art. A wireless signal, such as a radio frequency signal, may be received by a receiving unit or by a receiving module of the ED 110, RAN node 170. A wireless signal may be processed by a processing unit or a processing module of the ED 110. The receiving unit or module may perform source decoding and channel decoding at the media access control (MAC) layer and physical layers as is known to a person skilled in the art. Other operations, including generation of an inference job that includes one or more inference requests and the encoding of the input data of each inference request, may be performed by an artificial intelligence (AI) or machine learning (ML) module of the ED 110. The respective units or modules may be implemented using hardware, one or more components or devices that execute software, or a combination thereof. For example, one or more of the units or modules may be an integrated circuit, such as a programmed FPGA, a GPU or an ASIC. It will be appreciated that where the modules are implemented using software for execution by a processor, for example, the instructions modules may be retrieved by a processor, in whole or part as needed, individually or together for processing, in single or multiple instances, and that the modules themselves may include instructions for further deployment and instantiation.

Additional details regarding the EDs 110, the RAN nodes 170 are known to those of skill in the art. As such, these details are omitted here.

An air interface generally includes a number of components and associated parameters that collectively specify how a transmission is to be sent and/or received over a wireless communications link between two or more communicating devices (e.g. between a EDs 110 and one or more RAN nodes 170, a RAN node 170 and one or more EDs 110, or between EDs 110). For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may be a link between a RAN node 170 (such as a T-TRP or a NT-TRP) and an ED 110 (e.g., a “Uu” link), and/or the wireless communications link may be a link two EDs 110 (e.g., a “sidelink”), and/or the wireless communications link may be a link between a non-terrestrial (NT)-communication network and an ED 110. The following are some examples for the above components.

A waveform component may specify a shape and form of a signal being transmitted. Waveform components may include orthogonal multiple access waveforms and non-orthogonal multiple access waveforms. Non-limiting examples of such waveform components include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all EDs 110 or a group of EDs 110. For this case, the slot configuration information may be transmitted to the EDs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a RAN node 170, and an uplink portion, for uplink transmissions from the EDs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A RAN node 170, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a RAN node 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the ED 110 as a function of other parameters that are known by the ED 110, or may be fixed, e.g., by a standard.

Position information for an ED 110 (referred to hereinafter as ED position information) is often used in cellular communication networks to improve various performance metrics for the network. Such performance metrics may, for example, include capacity, agility and efficiency. The improvement may be achieved when elements of the network exploit the position, the behavior, the mobility pattern, etc., of the ED 110 in the context of a priori information describing a wireless environment in which the ED 110 is operating.

A sensing system may be used to help gather ED pose information, including a location of an ED 110 in a global coordinate system, a velocity of an ED 110 and direction of movement in the global coordinate system, orientation information and the information about the wireless environment. “Location” is also known as “position” and these two terms may be used interchangeably herein. Examples of well-known sensing systems include RADAR (Radio Detection and Ranging) sensing system and LIDAR (Light Detection and Ranging) sensing system. While the sensing system can be separate from the communication system, it could be advantageous to gather the information using an integrated system, which reduces the hardware (and cost) in the integrated system as well as the time, frequency or spatial resources needed to perform both functionalities. However, using hardware of the communication system to perform sensing of ED pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and RAN nodes 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple RAN nodes 170. In other aspects of the present application, the SMF may be implemented as a logical entity co-located inside a RAN node 170 through logic carried out by the processor 260.

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the ED 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication network may be a wireless communications network using 5G technology and/or later generation wireless technology (e.g., 6G or later). In some examples, the terrestrial communication network may also accommodate some legacy wireless technologies (e.g., 3G or 4G wireless technology). The non-terrestrial communication network may be a communications network using satellite constellations, like conventional Geo-Stationary Orbit (GEO) satellites, which utilize broadcast public/popular contents to a local server. The non-terrestrial communication network may be a communications system using low earth orbit (LEO) satellites, which are known to establish a better balance between large coverage area and propagation path-loss/delay. The non-terrestrial communication network may be a communications network using stabilized satellites in very low earth orbits (VLEO) technologies, thereby substantially reducing the costs for launching satellites to lower orbits. The non-terrestrial communication network may be a communications network using high altitude platforms (HAPs), which are known to provide a low path-loss air interface for the users with limited power budget. The non-terrestrial communication network may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the RAN nodes 170 that are T-TRPs and/or NT-TRPs may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication network with RAN nodes 170 that are T-TRPs and/or the NT-TRPs configured with a large number of antennas has gained wide attention from academia and industry. In the large-scale MIMO system, a RAN node 170 that is a T-TRP, and/or a RAN node 170 that is NT-TRP, is generally configured with more than ten antenna units (see antennas 256 and antennas 280 in FIG. 3). A RAN node 170 that is T-TRP, and/or a RAN node 170 that is a NT-TRPs, is generally operable to serve dozens (such as 40) of EDs 110. A large number of antenna units of the RAN node 170 that is T-TRPs and a RAN node 170 that is a NT-TRP can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the RAN node 170 that is a T-TRP and the RAN node 170 that is a NT-TRP of each cell can communicate with many EDs 110 in the cell on the same time-frequency resource at the same time, thus greatly increasing the spectrum efficiency. A large number of antenna units of a RAN node 170 that is a T-TRP 170 and/or a RAN node 170 that is a NT-TRP also enable each user to have better spatial directivity for uplink and downlink transmission, so that the transmitting power of the RAN node 170 that is a T-TRP 170 and/or the RAN node 170 that is a NT-TRP and an ED 110 is reduced and the power efficiency is correspondingly increased. When the antenna number of the RAN node 170 that is T-TRP and/or the RAN node 170 that is a NT-TRP is sufficiently large, random channels between each ED 110 and the RAN node 170 that is a T-TRP and/or the RAN node 170 that is a NT-TRP can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system includes: a panel; and a beam.

A panel is a unit of an antenna group, or antenna array, or antenna sub-array, which unit can control a Tx beam or an Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or an Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

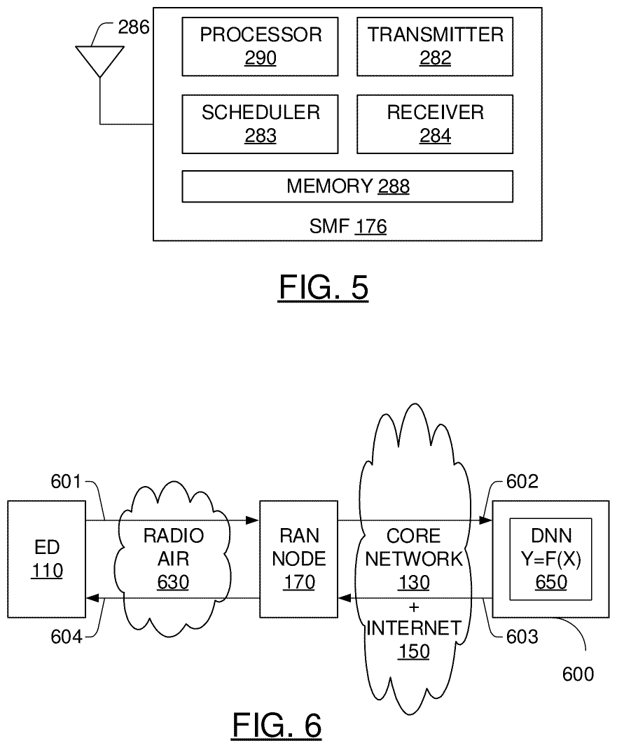

DNNs that are trained to perform various different tasks, such as a computer vision task, a natural language processing task, a speech recognition task, may be hosted on remote computing systems, such as cloud computing systems. EDs 110 may communicate with such remote computing systems via next generation communication systems, such as the communication system 100 illustrated in FIGS. 1 and 2 to access a DNN that are hosted on a remote computing system. In a typical scenario, illustrated in FIG. 6, an application running on an ED 110 generates a request for DNN 650 hosted on computing system 600 and the ED 110 sends a wireless transmission 601 that includes a request for the DNN 650 hosted on (i.e., deployed and running on) a computing system 600 to perform inference on input data included in the request. The DNN 650 is configured to perform a particular task (e.g., trained to perform a particular task such as a computer vision task, a speech signal processing task, a natural language processing task). When a request specifies that the DNN 650 is to perform inference for input data included in the request, the request sent by the ED 110 may be called an “inference request.” An inference request may include input data. Upon receipt, at a RAN node 170 over a radio/air interface 630, of wireless transmission 601 that contains an inference request, the RAN node 170 transmits a further transmission 602 that contains the inference request to the computing system 600 that hosts the DNN 650. The RAN node 170 may transmit the further transmission 602 to the computing system 600 via the core network 130 directly or to the core network 130 and via the Internet 150, which in turn forwards the further transmission 602 to the computing system 600. As illustrated in FIGS. 1 and 2, the core network 130 may be connected to the computing system 600 through the Internet 150.

Although the DNN 650 is shown hosted on the computing system 600 that connected to core network 130 directly (or indirectly via the Internet 150) in FIG. 6, in the communication system 100, the DNN 650 may be hosted on other types of computing systems. For example, the DNN 650 may be hosted in one or more edge nodes, where the one or more edge nodes are located close to, and connected to, a RAN node 170. Alternatively, the DNN 650 may be hosted on a computing system of a RAN node 170 (i.e., deployed and running on a computing system of a RAN node 170).

It will be appreciated that, although only one DNN 650 is shown in FIG. 6, computing system 600 may be hosting multiple DNNs, where each DNN is configured (i.e., has been trained) to perform a different task.

When the further transmission 602 containing the inference request is received by the computing system 600 that hosts the DNN 650, the input data, included in the inference request, may be queued by the DNN 650. In turn, the DNN 650 carries out the inference request (i.e., performs inference using the input data contained in the inference request). When the DDN 650 completes the inference, inference data is output by the DNN 650. The inference data may include a prediction generated by the DNN 650 based on the input data. The computing system 600 transmits, via the core network 130 (or via a combination of the Internet 150 and the core network 130), a backbone transmission 603 that includes the inference response to the RAN node 170 associated with the requesting ED 110. The RAN node 170 then transmits, over the air 630, a wireless transmission 604, which includes the inference response, to the ED 110.

The typical scenario, described hereinbefore, may be seen to have at least one flaw in that it appears that there is no guarantee of a trustworthiness of the inference response contained in the wireless transmission 604 received by the ED 110 from the RAN node 170 or the backbone transmission 603 received by the RAN node 170 from the computing system 600 hosting the DNN 650.

Traditional communication systems are known to establish secure and reliable, and even confidential, transmissions over the air 630 and within the core network 130. These known secure and reliable transmissions do not help to ensuring the trustworthiness of input data included in an inference request and inference data received in an inference response, generated and output by the DNN 650.

In view of FIG. 6, it is notable that an inference request, originating at the ED 110 and destined for the DNN 650, may be subject to two major types of malicious attacks. A Type-I malicious attack may be defined as being related to a malicious operation of the DNN 650 or related to tampering with one of the transmissions 601, 602 that contain the inference request; whereas, a Type-II malicious attack may be defined as being related to tampering with one of the transmissions 603, 604 that contain the inference response. To protect against both Type-I and Type-II malicious attacks, it is proposed herein to establish a method of certifying trustworthiness for inference requests and inference responses in a communication system that connects the ED 110, the RAN node 170 (edge computation node) and the computing system 600 that hosts the DNN 650. In one aspect, the method of certifying trustworthiness involves establishing a level of confidence that the input data received at the DNN 650 is the same as the input data that was transmitted by the ED 110. In another aspect, the method of certifying trustworthiness involves establishing a level of confidence that the inference data received at the ED 110 is the same as the inference data that was generated by the DNN 650.

Unfortunately, little attention has been focused on the trustworthiness of inference data included in an inference response that is received in a wireless transmission from a RAN node 170. By default, the computing system 600 hosting the DNN 650 demands an unconditional trust grant for inference responses. That is, the end users are expected to trust that inference data received, indirectly, from the computing system 600 hosting the DNN 650, is the inference data that is a result of the DNN 650 performing inference on the particular input data provided by an end user to the DNN 650. Such an unconditional trust grant presents a great potential safety issue in a future, wireless-based society. In a near future, a high density of IOT-UEs, such as driverless cars and industrial automation factory components connected to a RAN 120 of a communication system 100, may be expected to penetrate into a wide variety of industries. It may reasonably be expected that a malicious attack on the DNN 650 would cause havoc. Indeed, there is no guarantee that the computing system 600 hosting the DNN 650 will not cut corners, for economic benefit, thereby having an effect analogous to a malicious attack. Such corner cutting may, for example, involve an unscrupulous provider of a cloud computing system that offers access to DNN 650 as a service arranging the DNN 650 generate and output inference responses that include inference data that are unrelated to corresponding received input data.

Besides the trustworthiness and privacy protection issues from a point of view of the ED 110, there is also a similar issue from a point of view of the DNN 650. If a third party eavesdrops on a sufficient number of pairs of inference requests, included in the transmissions 602 sent to the computing system 600 hosting the DNN 650, and inference responses, included in the 603 transmissions 603 sent by the computing system 600 hosting the DNN 650, a third party could configure (i.e., train) a third party DNN to be similar to the DNN 650 using the input data contained in the inference requests and the inference data contained in the inference responses.

In overview, aspects of the present application relate to a trustworthiness certification method. The trustworthiness certification method includes evaluating the trustworthiness of an inference response received from the computing system 600 that hosts the DNN 650 via transmissions in a communication system. Conveniently, aspects of the present application relate to preventing theft of or malicious attacks on the inference requests contained in the transmissions 601, 602 and inference responses contained in the transmissions 603, 604.

For an inference job, the requesting ED 110 transmits one or more inference requests for the DNN 650 to the computing system 600 that hosts the DNN 650 via the RAN node 170 and the DNN 650 generates inference responses, corresponding to each inference request, that are transmitted by the computing system 600 back to the ED 110 via the core network 130 and the RAN node 170 (or via the Internet 150, the core network 130, and the RAN node 170). An inference request may be understood to include both a control header, input data and optionally other information. The inference request may be transmitted over one or more uplink transmission intervals. For example, if the inference request includes high-definition video, a frame of the video may be transmitted over several source blocks, using several code-words that may be transmitted over multiple uplink transmission intervals. For another example, if the inference request includes a simple text, the inference request may be transmitted over one source block, using one code-word during one uplink transmission interval.

There is a concern regarding privacy of inference requests and of inference responses. The inference requests and the inference responses are contained in wireless transmissions 601, 604, respectively, that are transmitted between the ED 110 and the RAN node 170 over the air 630. The inference requests and the inference responses are also contained in transmissions 602, 603, respectively, that are transmitted between the RAN node 170 and the computing system 600 that hosts the DNN 650 via the core network 130, or via the core network 130 and the Internet 150. Accordingly, malicious attacks may take place on the wireless transmissions 601, 604 or the transmissions 602, 603 including hacking, eavesdropping, tampering, replacing or blocking.

There is also a concern regarding theft of raw data, i.e., the input data included in an inference request. For example, if the ED 110 is a self-driving car, video data generated by a digital camera mounted to the self-driving car forms the basis of the input data to be used for an inference of pedestrian detection. The video data generated by the camera may contain some private data. In such a case, it may be considered to be undesirable for the video data to be obtained by a third party. This is of particular concern if the third party is also able to access to predictions (e.g. the inference data) contained in an inference response generated and output by the DNN 650 responsive to the inference requests. If the third party is able to access the input data provided to the DNN 650 and the inference data output by the DNN 650 on a large number of occasions, the third party may consider, at some point, that a sufficient number of pairs of inference requests and inference responses have been accumulated to form a new training dataset comprising training data samples, where each training data sample includes the input data and the inference data of a pair of inference requests and inference responses. The accumulated pairs are, clearly, not the pairs that formed the training data set used to train the DNN-on-Cloud 650. However, the third party may use the new training data set to train a malicious DNN with a machine learning algorithm such that the malicious DNN has similar parameters and performance as the DNN 650.

In theory, an ED 110 could accumulate a plurality of pairs of inference requests and inference responses. However, it is considered that it would be rare and hard for an ED 110 to accumulate a large enough number of pairs of inference requests and inference responses from a targeted DNN, such as DNN 650, with a suitable amount of diversity to successfully train a DNN that mimics the targeted DNN well. Because a RAN node 170 can communicate with a large number of different EDs 110 and the computing system 600 hosting the DNN 650, it is considered that the number and diversity of pairs of inference requests and inference responses that may be accumulated at the RAN node 170 may be sufficient to the purpose of successfully training a malicious DNN which is substantially similar to the DNN 650.

Aspects of the present application relate to using a trustworthiness certification method which addresses the concerns described hereinbefore. However, the trustworthiness certification method of the present disclose may lead to performance of some extra computations on inference responses which are transmitted over the communication system 100. EDs 110, especially EDs 110 that are IOT devices (“IOT-UEs”), may have limited computation resources. Thus, in some embodiments of the present application, an edge computing system (e.g. a RAN node 170 equipped with a computing system that includes a large amount of computing resources (e.g. memory and processing resources), or a computing system that includes a large amount of computing resources that is connected to the RAN node 170) may carry out the trustworthiness certification method of the present disclosure.

Consider an example wherein the ED 110 communicates, via the communication system 100, with the computing system 600 that hosts the DNN 650. The ED 110 transmits, to the RAN node 170 a wireless transmission 601 that contains an inference request for DNN 650. The inference request for DNN 650 contains input data, X, and information that allows for identification, at the RAN node 170, of the DNN 650. An inference request may contain more than just input data, X, and the information that allows for identification of the DNN 650. Indeed, it should be clear that an inference request includes one or more control headers and, perhaps, other portions related to the DNN 650 such as input current precision if dynamic precision is allowed, support for early termination if early termination is allowed, latency priority, and so on. The RAN node 170 receives the wireless transmission 601, obtains the inference request from the wireless transmission 601, and transmits a further transmission 602, containing the inference request, to the computing system 600 that hosts DNN 650 via the core network 130 and/or the Internet 150. The further transmission 602, which contains the inference request, may, for example, be transmitted across some backbone connections in the core network 130 and some connections in the Internet 150. Upon receipt of the further transmission 602, at the computing system 600 that hosts the DNN 650, the inference request may be added to a service queue of DNN 650. After the DNN 650 serves the inference request (i.e., the DNN 650 completes inference on the input data, X, included in the inference request and generates inference data, Y), the DNN 650 generates and outputs an inference response for the inference request. The inference response includes the inference data, Y. The DNN 650 provides the inference response to the computing system 600 which transmits the inference response to ED 110. The inference response is transmitted to the ED 110 in two transmissions: a first transmission being a backbone transmission 603 from the computing system 600 that hosts the DNN 650 to the RAN node 170 via the core network 130 and/or the Internet 150; and a second transmission being a wireless transmission 604 from the RAN node 170 to the ED 110. It should be clear that an inference response contains more than just the inference data, Y, generated by the DNN 650 based on the input data, X. Indeed, it should be clear that an inference response includes one or more control headers and, perhaps, other portions to indicate the ED 110 that is a destination for the inference response.

Referring again to FIG. 6, malicious attacks may take place on the transmissions 601, 602 that contain an inference request that contains the input data, X, the transmissions 603, 604 that contain the inference response that contains the inference data, Y, and on the DNN 650. A malicious attack on the transmissions 601, 602 that contain an inference request that includes the input data, X, could delete, tamper, poison, eavesdrop or even replace the input data, X, contained in the inference request. Similarly, a malicious attack on the transmissions 603, 604 that contain an inference response that includes the inference data, Y, may delete, tamper, poison, eavesdrop or even replace the inference data, Y. Another malicious attack may be attempted by way of establishing an unauthorized DNN in place of the authorized DNN 650, allowing access to the unauthorized of the DNN or by carrying out a phishing attempt on a human in an administrative role related to the computing system 600 that hosts the DNN 650. A malicious attack to the DNN 650 may cause the DNN 650 to appear to generate and output an inference response based on the input data, X, but the DNN 650 may, in fact, generate and output random noise in place of appropriate inference data, Y, for the input data, X. Alternatively, a malicious attack to the DNN 650 may result in the DNN 650 being compromised so that the DNN 650 multicasts a single inference response to a number of EDs 110 that have sent inference requests containing distinct input data, X, to the DNN 650. One economic and competitive motivation for a provider of the DNN 650 (e.g. provider of a computing system that hosts the DNN 650) to execute such malicious attack relates to the fact that the DNN 650 may require significant computational resources (e.g. memory and processing resources) for inference (i.e., to carry out the operations of the DNN 650 to perform inference) and, hence, the computing system 600 that hosts the DNN 650 may consume a significant amount of energy when performing inference. All of the possible malicious attacks above would result into malicious inference responses.

Future communication networks have the potential to deliver trustworthy services, such a DNNs that perform particular tasks as a service, to a great number of IOT EDs (also called “IOT devices”). It may be easily understood that malicious attacks have the potential to undermine safety criticality and, thereby, cause significant social and economic damages.

IOT EDs are expected to be low-power and low-cost devices that do not have hardware or power that is sufficient to run complicated certification algorithms against malicious attacks all the time. It follows that IOT EDs may be configured to rely on a RAN nodes 170 as a last stand to not only filter out malicious inference responses but also protect the privacy of inference requests and corresponding inference responses. Fortunately, future RAN nodes 170 are expected to possess computational and storage resources suitable to allow an exemplary RAN node 170 to take on a role as an edge computation system. However, the same future RAN nodes 170 are not expected to possess computational resources for carrying out computations of a DNN or storage resources suitable for a storing DNN which can have billions, or even trillions, of parameters.

As has been discussed hereinbefore, a computing system (e.g. the computing system 600) that host a DNN (e.g. DNN 650) and provides access to the DNN (e.g. DNN 650) as a service may be concerned about DNN stealing. If a third party successfully eavesdrops on transmissions containing the inference requests and transmissions containing the inference response that includes the inference data generated by the DNN (e.g. DNN 650) for the inference request, the third party could accumulate a number of training data samples that is sufficient to allow the third party to recreate or train a new DNN similar to the DNN (e.g. DNN 650), thereby engaging in DNN stealing.

The trustworthiness of an ED (e.g. ED 110) to access a DNN (e.g. DNN 650) hosted on a computing system (e.g. computing system 600), involves three entities, the ED 110, the RAN node 170 and the DNN on the computing system (e.g. the DNN 650 hosted on the computing system 600). The RAN node 170 may be equipped with powerful enough computation resources that the RAN node 170 may be called an “edge computation node.” The ED 110, though low energy and low cost, may be shown to benefit from trustworthiness certification against any malicious attack and a privacy protection against tapping and interception of communications (e.g. the transmission 601, 602) related to inference jobs. The computing system (e.g. the computing system 600) that hosts the DNN (e.g. DNN 650) and provides access to the DNN (e.g. DNN 650) as a service may be shown to benefit from preventing theft of the DNN through interception of transmissions related to training the DNN.

Aspects of the present application relate to using coding theory to provide a trustworthiness certification method for both ensuring that the input data, X, which is included in an inference request transmitted from the ED 110 to the computing system that hosts the DNN 650, and inference data, Y, which is included in an inference response transmitted from the computing system that hosts the DNN 650 to the ED 110 are trustworthy.

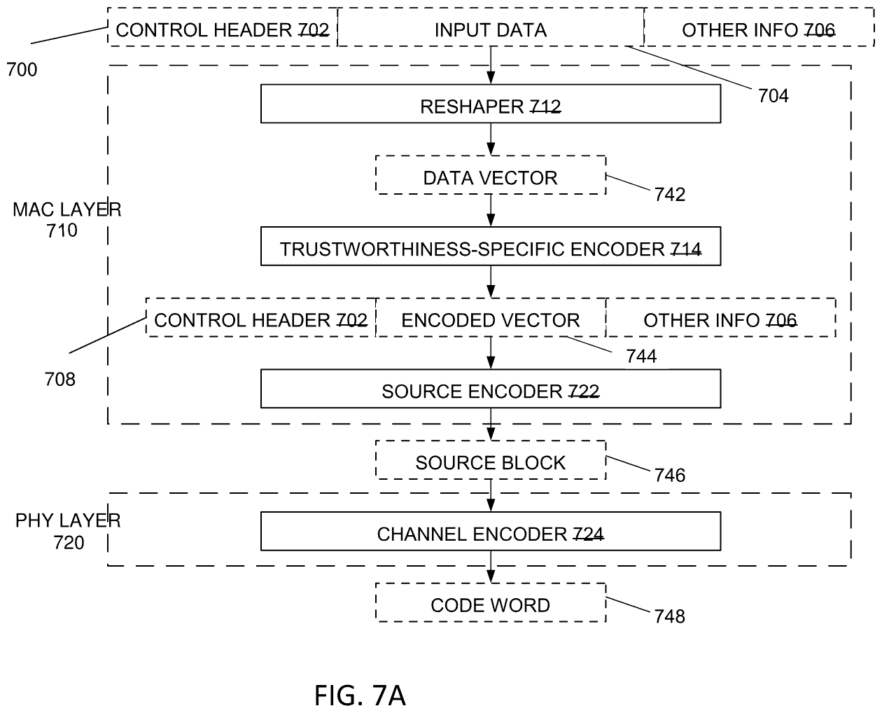

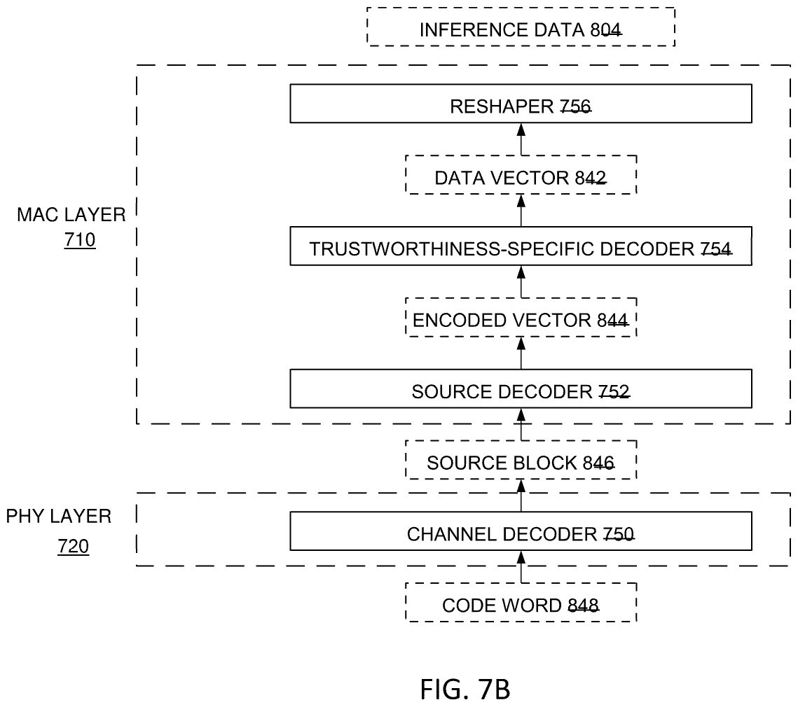

FIG. 7A illustrates components an ED 110 that responsible, in part, for processing an inference request 700 using code theory to ensures input data X (704) which is included in an inference request 700 transmitted by the ED 110 to the computing system 600, is trustworthy. An inference request for DNN 650 is generated by an application running on the ED 110 that requests inference for input data X (704). The inference request 700 for DNN 650 is illustrated as including an inference request control header 702, input data X (704) and optional other information 706. The input data X (704) may be integer or floating point. As shown in FIG. 7A, a media access control (MAC) layer 710 of the ED 110 includes a reshaper 712, a trustworthiness-specific encoder 714, and a source encoder 720. A physical (PHY) layer 720 of the ED 110 includes a source encoder 722 and a channel encoder 724.

The input data X (704) included in an inference request 700 for DNN 650 is provided to reshaper 712 which process the input data X (704) to generate an input data vector X* (742). The input data vector X* (742) is illustrated, in FIG. 7A, as the output of the reshaper 712. In cases wherein the input data X (704) is integer or floating point, it is expected that the input data vector X* (742) will also be integer or floating point.

Along with being integer or floating point, the input data X (704) may have high dimensionality. As an example input data X (704) is image data corresponding to an image. In this case, the example input data X (704) is two-dimensional and each pixel of the image is represented by an integer value. Another example of input data X (704) is based on text (e.g. one-hot encodings of words of a sentence). In this case, the example input data X (704) is one-dimensional vector and each word in the one-dimensional vector is one-hot encoding.

An encoded input vector 744 is illustrated, in FIG. 7A, as the output of the trustworthiness-specific encoder 714. In cases wherein the input data vector X* (742) is integer or floating point, it is expected that the encoded input data vector (744) will also be integer or floating point.

The trustworthiness-specific encoder 714 may add some coding redundancy to the encoded input vector 744, in which case, processing, by the trustworthiness-specific encoder 714, of the input data vector X* (742) may be shown to improve transmission robustness.

After the trustworthiness-specific encoder 714 generates the encoded input vector 744, an encoded inference request 708 is reformed at the MAC layer 710 of the ED 100 which includes the control header 702, the encoded input vector (744), and the other information 706. The encoded inference request 708 is the passed to the source encoder 722, where the encoded inference request 708 is processed by the source encoder 722. The output of the source encoder 722 is a source block 746. The source encoder 722 may apply quantization and add compression to the inference request. Accordingly, the source block 746 is expected to be binary. The source encoder 722 may also segment the inference request into multiple binary source blocks 746. That is, the output of the source encoder 722 may be a plurality of source blocks 746.

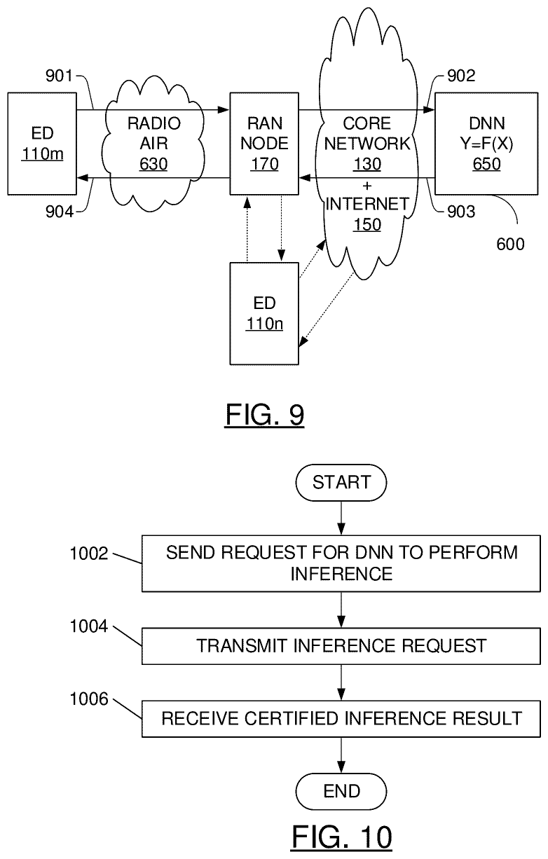

The source blocks 726 are then passed to the channel encoder 724 of the PHY layer 720. The channel encoder 720 processes each respective source block 746 to protect the respective source block 746 against hostile radio or wired channels. The output of the channel encoder 724 is a (binary) code word 748. It is the code word 748 that is transmitted, by the ED 110, as a wireless transmission 901 (see FIG. 9).

In some aspects of the present disclosure, the trustworthiness encoder 714 may be implemented in a MAC layer of a RAN node 170. In these aspects of the present disclosure, the inference request 700 is provided to the source encoder 722, which generates source blocks as described above. The source blocks 746 are provide to a channel encoder which generates the code word 748 as described above. The RAN node 170 receives the code word 748, decodes the code word 748 using a channel decoder (not shown) to obtain the source blocks 746, and decodes the source blocks 746 to obtain the input data vector 742. The RAN node 170 may store the input data vector 742 in memory. The trustworthiness encoder 714 implemented in the MAC layer of the RAN node 170 then receives the input data vector 742 and generates the encoded input data vector 744. The RAN node 170 then regenerates the encoded inference request 708, which includes the control header 702, the encoded input data vector 744 and the other information 706, and transmits the encoded inference request 708 to the computing system 600 in a transmission 902 (see FIG. 9).

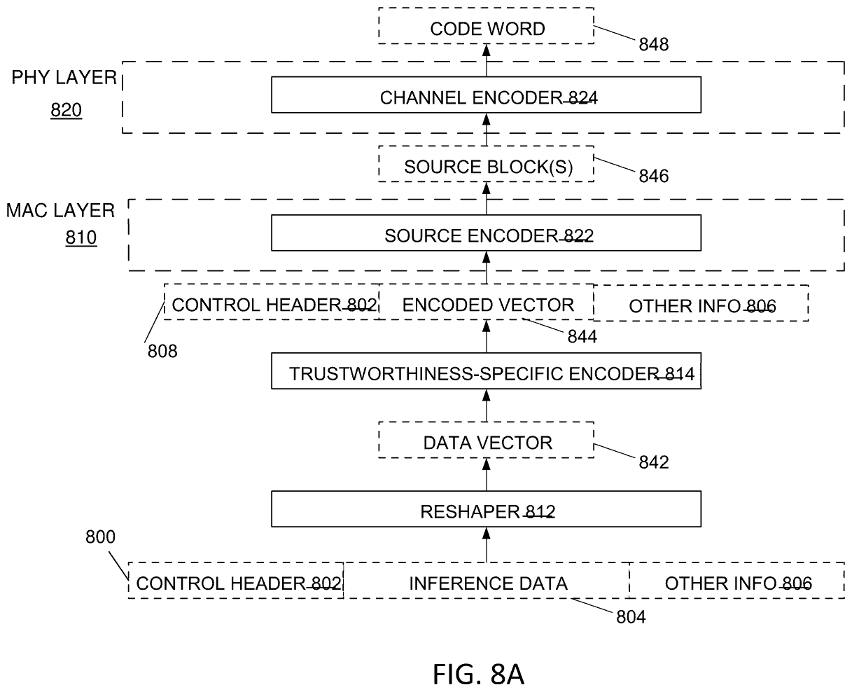

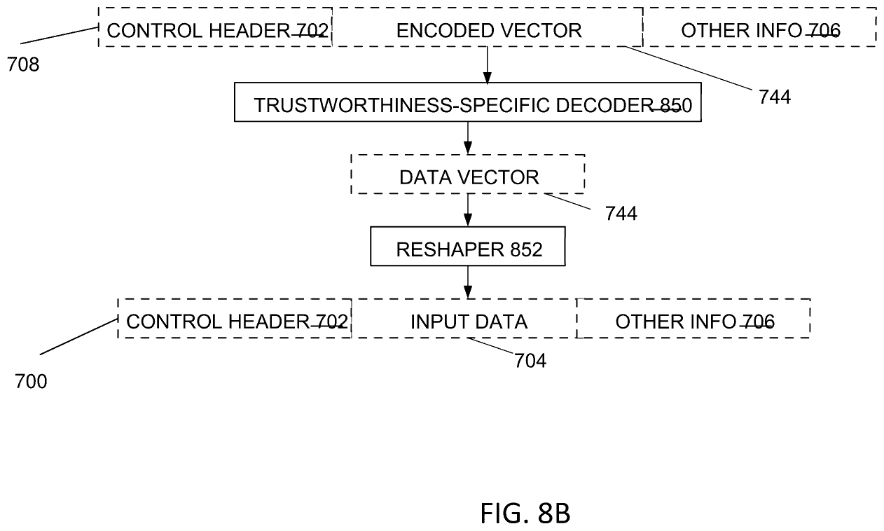

FIG. 8A illustrates components of the computing system 600 and a RAN node 170 that are responsible, in part, for processing an inference response 800 generated and output by the DNN 650. The inference response 800 as illustrated includes a response control header 802, inference data Y (804) generated by the DNN 650 and optional other information 806. The inference data Y (804) may be integer or floating point. The reshaper 812 and the trustworthiness-specific encode 814 shown in FIG. 8A are implemented at the computing system 600 that host the DNN 650. The MAC layer 810 and the PHY layer 820 are implemented at a RAN node 170. The MAC layer 810 implemented at the RAN node 170 includes a source encoder 822. The PHY layer 820 implemented at the RAN node 170 includes a channel encoder 824.

An inference data vector Y* (842) is illustrated, in FIG. 8A, as the output of the reshaper 812. In cases wherein the inference data Y (804) is integer or floating point, it is expected that the inference data vector Y* (842) will also be integer or floating point.

An encoded inference data vector W (844) is illustrated, in FIG. 8A, as the output of the trustworthiness-specific encoder 814. In cases wherein the inference data vector Y* (842) is integer or floating point, it is expected that the encoded inference data vector W (844) will also be integer or floating point.

As will be discussed, goals of the trustworthiness-specific encoder 814 include allowing the ED 110 or the RAN node 170 to detect a malicious inference response and protecting user privacy.

After the encoded inference data vector W (844) is the processed by the source encoder 822 of the RAN node 170. The output of the source encoder 822 is a source block 846. The source encoder 822 may act to apply quantization and add compression to the inference response that includes the encoded output vector 844. Accordingly, the source block 846 is expected to be binary. The source encoder 822 may also act to segment the encoded output vector W (844) into multiple binary source blocks 846. That is, the output of the source encoder 822 may be a plurality of source blocks 846.

The channel encoder 824 at the PHY layer 820 of the RAN node processes each source block 846 to protect the source block 846 against hostile radio or wired channels. The output of the channel encoder 824 is a (binary) code word 848. It is the code word 848 that is transmitted, by the computing system 600 that hosts the DNN 650, as a transmission 904 (see FIG. 9) to ED 110 as described in further detail below.

Referring to FIG. 7B, components of the ED 110 that are responsible, in part, for processing an encoded inference response 800 are illustrated. As shown in FIG. 7B, the ED 110 receives the code word 848 and decodes, using a channel decoder 750 of the PHY layer 710 to generate the source block(s) 846. The channel decoder 750 performs the inverse operation of the channel encoder 824 to generate source block(s) 846. The channel decoder 750 outputs the source block(s) 846 which are provided to a source decoder 752 at the MAC layer 710 of the ED 110. The source decoder 752 at the MAC layer 710 of the ED 110 performs the inverse operation of the source encoder 822 to generate the encoded inference data vector W (844) and outputs the encoded inference data vector W (844) which is provided to a trustworthiness-specific decoder 754 of the MAC layer 710 of the ED 110. The trustworthiness-specific decoder 754 of the MAC layer 710 of the ED 110 performs the inverse operation of the trustworthiness-specific encoder 814 to generate the inference data vector Y* (842) and outputs the inference data vector Y* (842). The inference data vector is then provided to a reshaper 756 of the MAC layer 710 of the ED 110. The reshaper 756 of the MAC layer 710 of the ED 110 performs the inverse operation of reshaper 812 to reshape the inference data vector Y* (842) into the inference data Y (804). The inference data Y (804) is the passed to the application at the ED 110 which generated the inference request 700.

Referring to FIG. 8B, components of the computing system 600 that are responsible, in part, for processing an encoded inference request 708 as illustrated. As shown in FIG. 8B, the computing system 600 receives the encoded inference request 708. The computing system 600 includes a trustworthiness-specific decoder 850 that performs the reverse operation of the trustworthiness-specific encoder 714. The trustworthiness-specific decoder 850 receives the encoded input data vector Z (744), generates the input data vector X* (744) based on the input data vector Z (744) and outputs the input data vector X* (744). The computing system 600 also includes a reshaper 852 that performs the inverse operation of the reshaper 712. The reshaper 852 receives the input data vector X* (744), generates the input data X (704) based on the input data vector X* (744), and outputs the input data X (704). The computing system then forms the inference request 700 using the control header 702 and other information from the encoded inference request 708 and the input data X (704). The inference request 700 is then provided to the DNN 650 for inference.

As noted, a given malicious attack may be categorized in one of two types: Type-I malicious attacks; and Type-II malicious attacks. A trustworthiness certification method may include both Type-I certification and Type-II certification. Type-I certification may be seen to include verifying that inference data Y (804) is attributable to input data X (704). Type-II certification may be seen to include confirming an integrity of inference data Y (804).

Aspects of the present application relate to the trustworthiness-specific encoder 714, at the ED 110, applying a linear block code to the input data vector 742 and the trustworthiness-specific encoder 814, at the DNN 650, applying a linear block code to the inference data vector (842). The linear block codes not only support the trustworthiness certification against the Type-I and Type-II malicious attacks but also protect privacy of input data, X and the privacy of the inference data, Y and output by the DNN 650.

It may be shown that, if enough redundancy is injected by way of the linear block codes implemented by the trustworthiness-specific encoders 714/814 and more supplicated decoding algorithms are implemented, the coding gain allows each transmission to tolerate some channel erasure rates over transmission media, such as the radio/air interface 630 and the core network 130.

A Type-I malicious attack has been defined, hereinbefore, as being related to a malicious operation of the DNN 650. The DNN 650 may be defined as a deep neural network that approximates a non-linear function, F(·) (referred to hereinafter as DNN 650 (F(·)). A Type-I malicious attack has also been defined, hereinbefore, as being related to tampering with one of the transmissions 601, 602 that contains an inference request that includes the input data X (704). A typical malicious attack on the input data X (704) happens on the transmissions 601, 602 (see FIG. 6) that contains the inference request 700. The transmissions 601, 602 that contains the inference request 700 includes the wireless transmission 601, by the ED 110 to the RAN node 170, and a wired transmission through core network 130 (perhaps including transmission through a portion of the Internet 150), by the RAN node 170 to the DNN 650 or, more specifically, to a computing system that hosts the DNN 650.

Wireless transmissions that contain the inference request 700 that includes input data X (704) may be eavesdropped, poisoned, tampered or replaced. A malicious attack on a DNN 650 may be said to generate a malicious DNN 650. Due to some economic reasons, a malicious DNN may palter with incoming inference requests by either returning random noise as inference responses or by producing a single valid inference response and returning that single valid inference response responsive to a plurality of inference requests received from distinct EDs 110.

To certify against a Type-I malicious attack, the ED 110 and the RAN node 170 may act to determine whether the inference data Y (804) is the right inference data Y (804), where Y=F(X), for given input data X (704). A certification may, for example, involve determining a score for the trustworthiness of inference data Y (804) given specific input data X (704).

A Type-II malicious attack has been defined, hereinbefore, as being related to a malicious attack on inference data Y (804). A typical malicious attack on inference data Y (804) happens on an inference response transmission path. The inference response transmission path may, for example, include transmission 603, over the core network 130 (perhaps including the Internet 150), from the computing system that hosts the DNN 650 to the RAN node 170 that is associated with the ED 110 that sent an inference request for the DNN 650. The transmission path may, for another example, include wireless transmission 604, over the air 630, from the RAN node 170 to the ED 110. The transmissions 603, 604, which contain an inference response 800 that includes inference data Y (804) may be eavesdropped, poisoned or tampered with by hackers. That is, a Type-II malicious attack may relate to hackers changing a portion of the inference data Y (804).

To certify against a Type-II malicious attack, the ED 110 and the RAN node 170 may act to determine a trustworthiness (i.e., the integrity) of inference data Y (804). A certification may, for example, involve determining a score for the trustworthiness (i.e., the integrity) of inference data Y (804). Note that determining a score for the integrity of inference data Y (804), is unrelated to determining inference data, Y, as result of input data, X, since that is the basis for certification against a Type-I malicious attack, discussed hereinbefore. Instead, certification against a Type-II malicious attack may involve certification against the trick played by a malicious DNN that multicasts one valid inference response for each of a plurality of other inference requests. Notably, trustworthiness certification for a Type-II malicious attack is expected to allow valid inference data Y (804), to score well, even if the inference data Y (804) would not pass trustworthiness certification for a Type-I malicious attack.

Besides guarding against the two types of malicious attacks, achieving bilateral trustworthiness may involve data protection. In aspects of the present application, the ED 110 may be configured to expect that inference requests transmitted by the ED 110 and inference responses received by the ED 110 to be coded against interception and eavesdropping. In aspects of the present application, a computing system that hosts a DNN may be configured to expect that all incoming inference requests and outgoing inference responses are also to be coded against interception and eavesdropping. From the perspective of the ED 110, such coding may be understood to relate to privacy protection; whereas from the perspective of the DNN 650, such coding may be understood to relate to protection of the DNN 650 and training dataset used to train the DNN 650.

In practice, Type-I trustworthiness certification, Type-II trustworthiness certification and protection of input data X (704) and inference data Y (804) may not be considered to be required together all the time. Some measures may only be taken to certify against Type-I malicious attacks; some measures may only certify against Type-I malicious attacks on inference requests; some measures may only be taken to certify against Type-II malicious attacks; and some measures may not take into account data protection at all. In the following discussion, each protocol of trustworthiness is, initially, described separately. Subsequently, various manners are discussed, in which manners the protocols may work together to provide a bilateral trustworthiness protocol.

The trustworthiness involves three entities: an ED 110; a RAN node 170; and the DNN 650. Between the ED 110 and the RAN node 170, there is the air interface 630. Between the RAN node 170 and the computing system 600 that hosts the DNN, there is the core network 130, which may include connections through the Internet 150.

According to aspects of the present application, a trustworthiness certification method may operate in one of three modes: a RAN node-mode; an ED/RAN node-mode; and an ED/RAN node/Cloud-mode. In the RAN node-mode, most of the certification-related computations are carried out on the RAN node 170. In the ED/RAN node-mode, certification-related computations are carried out by both the RAN node 170 and the ED 110 and transmissions between the RAN node 170 and the ED 110 are coded. In the ED/RAN node/Cloud-mode, certification-related computations are carried on by the ED 110, the RAN node 170 and the DNN 650 and all transmissions in the ED/RAN node/Cloud-mode are coded. According to aspects of the present application, the protocol of trustworthiness certification is flexible enough to meet various trustworthiness expectations and hardware conditions among the three entities.

In consideration of FIG. 9 and a certification method against Type-I malicious attacks in the RAN node-mode, it may be considered that an ED 110m transmits an inference request for DNN 650 to the RAN node 170 for transmission to the computing system 600 that hosts the DNN 650. The DNN 650 is understood to be a trained DNN which approximates a non-linear function, F(·) (“DNN 650 (F(·)” The DNN 650 is understood to be using the computing resources (e.g., infrastructure) of the computing system 600 to perform operations thereof. The DNN 650 is understood to be offered as a service by the computing system 600 to EDs 110. Through a wireless transmission (uplink) 901 and a core network transmission 902 that contains an inference request that includes an encoded input data vector 744, is provided to the computing system 600 that hosts the DNN 650. The RAN node 170 receives the wireless transmission (uplink) 901 (e.g. the code word 748), decodes the received code word 748 using a channel decoder (not shown) to obtain the source block(s) 746, and then decodes the source block(s) 746, using a source decoder (not shown) to obtain the inference request including the encoded input data vector 744. The RAN node 170 then transmits the inference request in a core network transmission 902 to the computing system via the core network 130 and the Internet 150.

The computing system 600 receives the core network transmission 902 that contains an encoded inference request 708 and processes the encoded inference request 708 to obtain the encoded input vector (744). The computing system 600 then decodes the encoded input data vector Z (744) using a trustworthiness-specific decoder 850 that performs an inverse operation (e.g. liner decoding) of the trustworthiness encoder 714 as described above to generate the input data vector Xₘ* (742) and reshapes the input data vector Xₘ* (742) using a reshaper 852 that performs the inverse operation of reshaper 712 as described above to obtain the input data Xₘ (704), where the subscript m indicates that the inference request is ED 110m.

After the input data Xₘ (704) is obtained by the computing system 600, the computing system 600 invokes the DNN 650 and provides the input data 704 (i.e. the input data Xₘ) to the DNN 650 which generates inference data Yₘ (804), where Yₘ=F(Xₘ)) based on the input data Xₘ (704). The computing system 600 that hosts the DNN 650 transmits an encoded inference response 808 that includes a control header 802, an inference data vector Yₘ* (842) generated by reshaper 812, and other information 806 to the RAN node 170 in a transmission 903. The RAN node 170 receives the transmission 903 containing the encoded inference response 808 and sends a transmission 904 that contains the encoded inference response 808 as described above with reference to FIG. 8A.

According to an aspects of the present application, a first certification protocol relates to establishing whether or not the inference data Yₘ, is random noise. From classic information theory, a non-linear function, F(·), can be regarded as a non-linear channel whose input is a random variable, X, and whose output is another random variable, Y. As a channel, the DNN 650, which is considered to have been trained to approximate the non-linear function, F(·), may be configured to provide a certain amount of mutual information between the two random variables, X and Y. The mutual information may take the form of channel capacity, which may be expressed as I(X; Y|F(·)). With an awareness of channel capacity, an entity may detect that random noise has been returned in response to a non-random-noise input. This is to say, it is expected that there be a certain amount of mutual information between valid inference data Y (804) and the input data X (704).

Aspects of the present application relate to determining a score of the trustworthiness for inference data Y (804) received in an inference response generated by the DNN 650 based on specific input data X (704) The score may be considered to relate to the extent of mutual information to be found in the inference data Y (804) which extent of mutual information is indicative of whether the inference data Y, has been randomly generated (lower score) or has been appropriately generated by the DNN 650 responsive to receiving the specific input data X, (higher score). An entity receiving the inference data Y (804) may measure the mutual information and compare the measured mutual information against a pre-defined threshold. Upon determining that the measured mutual information exceeds the threshold, the entity may consider that the inference data Y (804), is trustworthy.

However, since the DNN 650 approximates a function, F(·), which is a non-linear function, and since the dimension, l_{X}, of the input data X (704) and the dimension, l_{Y}, of the inference data Y (804) are usually different from each other (that is, l_{X}≠l_{Y}), it follows that the non-linear function, F(·), is irreversible. In consideration of this irreversibility, it may be seen as useful to create a “reverse certification DNN.” A function, G(·; θ), may be used to represent the reverse certification DNN. The reverse certification DNN may be configured to allow determination of a vector X′, where X′=G(Y; θ)=G(F(X); θ) and where θ represents parameters of the reverse certification DNN. The reverse certification DNN (otherwise referred to herein as reverse certification DNN G(·; θ)) is preferably trained using the same data set that was used to train the DNN 650 (otherwise referred to herein as DNN 650 (F(·)), but with a training target, θ*, related to minimizing a square error between X and X′. A training target, θ*, may be determined from

$${θ}^{*} = {\underbrace{arg min}}_{θ} ( {‖ G ( F ( X ) ; θ ) - X ‖}^{2} )$$

If the original training data set is unavailable, the reverse certification DNN, G(·; θ), can be trained using a training data set that is artificially generated by the DNN, F(·), which has been previously trained. It is expected that the computing system 600 that host the DNN 650 and provides access to the DNN 650 as a service will provide parameters, θ, for the reverse certification DNN, G(·; θ), that correspond to the DNN 650 that approximates the non-linear function, F(·). Note that G(·; θ) is expected to be far smaller than F(·) because G(·; θ) is designed to measure the mutual information between X and Y. It should be clear that mutual information is conceptual metric. In practice, a Euclidean distance may be used as a metric.

Consider that Xₘ denotes input data of an inference request for DNN 650 generated at the ED 110m and that Y denotes the inference data generated and output by the DNN 650 based on the input data Xₘ (704). FIG. 12 illustrates example steps in a method of certifying the trustworthiness of an inference response from the perspective of the RAN node 170. The RAN node 170 receives (step 1202), from the computing system 600 that hosts the DNN 650, a transmission 903 containing an inference response which includes inference data vector 842. The RAN node 170 obtains the inference data Y (804) for the input data Xₘ (704) from the inference data vector Y* (842) using a reshaper 852 that performs the inverse operation of reshaper 812. To certify whether the inference data Y (804) is the correct inference data for the input data Xₘ (704) rather than a randomly generated data, the RAN node 170 inputs the obtained inference data Y (704) into the reverse certification DNN (G(·; θₘ*)) to obtain (step 1204) estimated encoded input data Xₘ′, where Xₘ′=G(Y; θ*). The RAN node 170 then determines (step 1206) a square error |Xₘ′−Xₘ∥². Upon determining (step 1208) that the square error is less than a pre-defined threshold, T₁, that is, determining (step 1208) that ∥Xₘ′−Xₘ∥²<T₁, then the RAN node 170 may consider that the inference data Y (804) obtained from the received inference data vector Y* (842) is certified inference data vector Yₘ, that is, Yₘ=Y. Accordingly, the RAN node 170 may transmit (step 1210), to the ED 110m, a (Type-I) certified inference response. The certified inference response includes the certified inference data vector Y_{M}* generated from the certified inference data Yₘ. Upon determining (step 1208) that the square error is greater than the threshold (∥Xₘ′−Xₘ∥²>T₁), then the RAN node 170 may consider that the inference data Y (804) obtained from the inference data vector Y* (842) has no more significance than random generated noise.

This method may be shown to successfully distinguish randomly generated data from inference data Y (804) generated and output by DNN 650, even though the reverse certification DNN G(·; θ), is much smaller than the DNN 650 (F(·)). As may be expected, the certification of the inference data Y (804) may be shown to have false negatives, wherein the inference data Y (804) obtained from the inference data vector Y* (842) is the correct inference data, Yₘ, but is not certified as such. Similarly, as may be expected, the certification of the inference data Y (804) obtained from the inference data vector Y* (842) may be shown to have false positives, wherein the obtained inference data Y (804) is not the correct inference data Yₘ, but is certified as such. The rate of false positives and false negatives may be adjusted through appropriately adjusting the threshold T₁.

Notably, it may be shown that the act of determining architectures and parameters for the reverse certification DNN (G(·; θ)), discloses no information about the DNN 650 (F(·)). This lack of disclosure may be considered important to the computing system 600 that hosts the DNN 650 and provides access to the DNN 650 as a service in that information about the DNN 650 (F(·)), may be considered to be intellectual property of the organization that owns the computing system hosting the DNN 650 (F(·)),

Nevertheless, the use of a reverse certification DNN (G(·; θ)) as discussed hereinbefore, may be shown to not work well in case wherein the DNN 650 is a so-called malicious DNN. Such a malicious DNN may multicast one valid inference response upon receipt of multiple inference requests from multiple EDs 110. For example, a malicious DNN may transmit, to the ED 110m, an inference response including inference data Y (704) that actually belongs to another ED 110n (Y=Yₙ and Yₙ=F(Xₙ)). On the basis that the false inference data Yₙ, is not randomly generated, the false inference data is likely to pass a certification check that uses the reverse certification DNN (G(·; θ)).

As a solution to this, the trustworthiness-specific encoder 714 (see FIG. 7A) may be introduced. Notably, the trustworthiness-specific encoder 714 may also be referred to as a “transformer.” The trustworthiness-specific encoder 714 may make use of an encoding matrix designated “Uᵤₛₑᵣ” with dimensions l_{Z}×l_{X}. The encoding matrix, Uᵤₛₑᵣ, may be used to encode the input data vector Xᵤₛₑᵣ (742) a vector of l_{X}×1), into the encoded input vector Zᵤₛₑᵣ (744), where Zᵤₛₑᵣ=Uᵤₛₑᵣ·Xᵤₛₑᵣ (Zᵤₛₑᵣ is a vector of dimensions l_{Z}×1). By establishing that l_{Z}≥l_{X}, information loss during the encoding from Xᵤₛₑᵣ to Zᵤₛₑᵣ may be avoided. For a given ED 110, there may be established a ED-specific linear block encoding matrix, Uᵤₛₑᵣ. For the same given ED 100, there may be established an ED-specific certification DNN (G(·; θᵤₛₑᵣ*)), that is trained to minimize the square error in the Z domain rather than in the X domain. A training target, θᵤₛₑᵣ*, may be determined from

$${θ}_{u s e r}^{*} = {arg min}_{\underbrace{{θ}_{user}}} ( {‖ G ( F ( {X}_{u s e r} ) ; {θ}_{u s e r} ) - {U}_{u s e r} \cdot {X}_{u s e r} ‖}^{2} )$$

Notably, the pair [symbol] θᵤₛₑᵣ*, Uᵤₛₑᵣ [symbol] is user-specific. For example, if the DNN 650 is expected to serve 100 users, then the DNN 650 may be expected to allocate 100 user tokens, where each user token is related to a unique, user-specific pair [symbol] θᵤₛₑᵣ*, Uᵤₛₑᵣ [symbol] . For example, when the DNN 650 grants the ED 110m a user token-m, the DNN 650 develops a unique pair that includes an encoding matrix, Uₘ, and a certification DNN, G(·; θₘ*). The unique pair may be used to guard against Type-I attacks on each inference request sent by the ED 110m. It may be shown that randomly generated inference data Y would fail a certification test using the user-specific pair [symbol] θᵤₛₑᵣ*, Uᵤₛₑᵣ [symbol] approach. Additionally, it may be shown that another ED's 110n inference data Yₙ, would fail a certification test using the user-specific pair [symbol] θᵤₛₑᵣ*, Uᵤₛₑᵣ [symbol] approach.

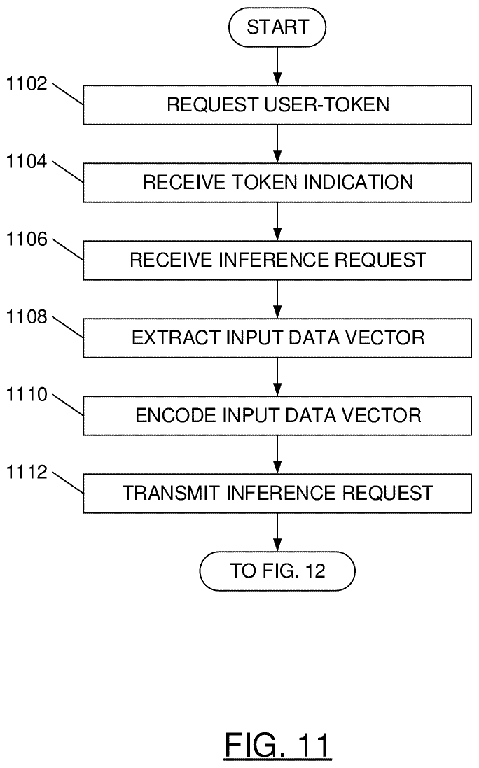

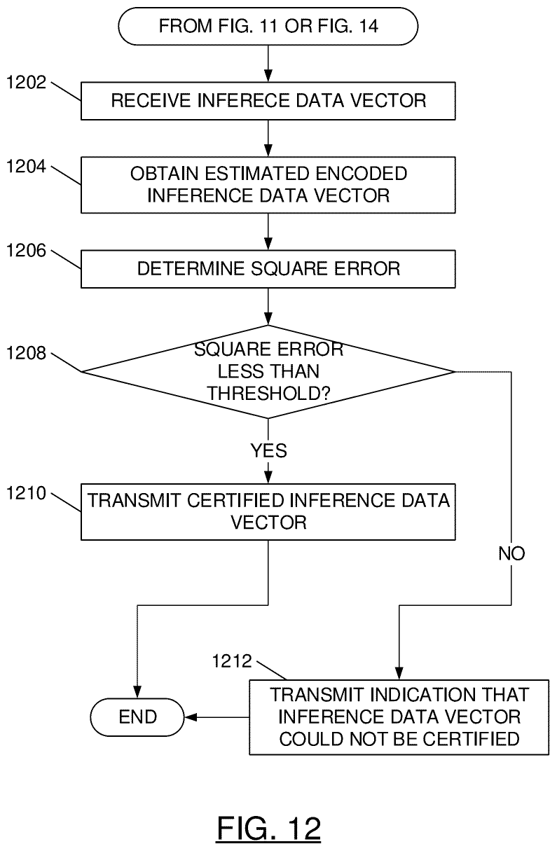

The user-specific pair [symbol] θᵤₛₑᵣ*, Uᵤₛₑᵣ [symbol] approach may be implemented on the RAN node 170, with the condition that the RAN node 170 has access to sufficient computation resources (e.g. processing and memory resources) to perform the Type-I certification (e.g. the RAN node 170 is an edge computing system or is connected to an edge computing system). FIG. 10 illustrates example steps in a method of obtaining a certified inference response from the perspective of the ED 110m. FIG. 11 illustrates example steps in a method of handling an inference request from the perspective of the RAN node 170. FIG. 12 illustrates example steps in a method of certifying an inference response from the perspective of the RAN node 170.

The ED 110m sends a request to the computing system 600 for DNN 650 hosted thereon to perform inference (step 1002, see FIG. 10). Responsive to receipt of the request for the DNN 650 to perform inference, the RAN node 170 requests (step 1102, see FIG. 11) a user-token from the DNN 650. The DNN 650 allocates a user-token, say token-m, to the ED 110m and the computing system 600 that hosts the DNN 650 sends user-specific pair [symbol] θₘ*, Uₘ [symbol] to the RAN node 170. It could be that the RAN node 170 has already stored a number of user-specific pairs [symbol] θᵤₛₑᵣ*, Uᵤₛₑᵣ [symbol] , in which case, the DNN 650 may simply send an instruction to the RAN node 170 to obtain the user-specific pair air [symbol] θᵤₛₑᵣ, Uᵤₛₑᵣ [symbol] related to token-m stored at the RAN node 170. Accordingly, the RAN node 170 may be understood to receive (step 1104) a token indication, whether the RAN node 170 receives an actual user-specific pair [symbol] θₘ*, Uₘ [symbol] or, simply, an indication of a user-specific pair [symbol] θₘ*, Uₘ [symbol] already stored at the RAN node 170.

The ED 110m transmits (step 1004) an inference request for DNN 650 to the RAN node 170. The inference request is transmitted in wireless transmission 901. The inference request for DNN 650 includes an input data vector Xₘ* (742) which has been generated by reshaper 712 at the ED 110m based on input data Xₘ (704). The RAN node 170 receives (step 1106) the inference request 700 for DNN 650. The RAN node 170 executes a Type-I certification process and extracts (step 1108), from the inference request 700 for DNN 650, the input data vector Xₘ* (742). The RAN node 170 further uses the Type-I certification process to encode (step 1110) the input data vector Xₘ* (742), into the Z domain by determining the encoded input vector Zₘ (744), where Zₘ=Uₘ·Xₘ. The RAN node 170 transmits (step 1112) an encoded inference request 708 for DNN 650 to the computing system 600 that hosts the DNN 650 (F(·)). The RAN node 170 transmits the inference request for DNN 650 in a transmission 902. The inference request includes the encoded input vector Zₘ (744), where Zₘ=Uₘ·Xₘ*.

Upon receiving (step 1202, see FIG. 12) the transmission 902 from the RAN node 170, the computing system 600 retrieves the encoded inference request 708 for DNN 650 from the transmission 902, decodes the encoded input vector Zₘ (744), where Zₘ=Uₘ·Xₘ*, using a trustworthiness-specific decoder 850 that performs the inverse operations of the trustworthiness encoder 714 as described above, to obtain the input data vector Xₘ (742). The computing system 600 then obtains the input data Xₘ (704) using reshaper 852 which performs an inverse operation of reshaper 712, as described above. The computing system 600 then invokes the DNN 650 and provides the inference request 700, which includes the control header 702, the input data Xₘ (704) and the other information 706, to the DNN 650. The DNN 650 then performs inference and generates inference data Y (804) based on the input data Xₘ (704). The DNN 650 then generates and output an inference response 800 that includes the inference data Y (804) as described above. The computing system 600 receives the inference response 800 and generates an encoded inference response 808 as described above. The computing system 600 then transmits to the RAN node 170 a transmission 903 that contains the encoded inference response 808. The RAN node 170 receives the transmission 903 that contains the encoded inference response 808 and extracts the encoded inference data vector W (844) from the encoded inference response 808. The RAN node 170 obtains the inference data vector Y* from the encoded inference data vector W (842) using a trustworthiness-specific decoder (not shown) similar to trustworthiness-specific decoder 714 and inputs the inference data vector Y* into the reverse certification DNN (G(·; θₘ*)), to obtain (step 1204) an estimated input data vector Zₘ′ (744), where Zₘ′=G(Y*; θₘ*). The RAN node 170 then determines (step 1206) a square error ∥Zₘ′−Zₘ∥². Upon determining (step 1208) that the square error is less than a pre-defined threshold T₁, that is, determining (step 1208) that ∥Zₘ′−Zₘ∥²<T₁, then the RAN node 170 may consider that the inference data vector Y* (842), is a certified inference data vector Yₘ*, that is, Yₘ*=Y*. Accordingly, the RAN node 170 may transmit (step 1210), to the ED 110m, the encoded inference response 808 in a wireless transmission 904 as described above with respect to FIG. 8A. The encoded inference response 808 includes the control information 802, the inference data vector Yₘ*, and the other information 806. The ED 110m receives (step 1006, FIG. 10) the encoded inference response 800.

Upon determining (step 1208) that the square error is greater than a pre-defined threshold, that is, upon determining (step 1208) that ∥Zₘ′−Zₘ∥²>T₁, the RAN node 170 may consider that the inference data vector Y* (842) is not certified and the RAN node 170 may take no further action. Alternatively, the RAN node 170 may transmit (step 1212), to the ED 110m, an indication that the inference data vector Y* (842) could not be certified.

Optionally, the RAN node 170 may bypass comparing (step 1208) the square error against a threshold. Instead, the RAN node 170 may transmit (step 1210), to the ED 110m, the received inference response including the inference data vector Y* (842). As part of transmitting (step 1210) the inference response, the RAN node 170 may also transmit, to the ED 110m, the square error value ∥Zₘ′−Zₘ∥², so that the ED 110m may have a measure of a degree to which the ED 110m may be confident that the received inference data vector Y* (842), may be expected to be representative of a certified inference data vector Yₘ*. That is, the RAN node 170 may, by transmitting the square error value to the ED 110m, provide a value representative of a trustworthiness score to associate with the received inference data vector Y* (842).

The trustworthiness certification methods described with reference to FIGS. 8, 11 and 12 involve only the RAN node 170 and the computing system 600 that hosts DNN 650. It is notable that a transmission 901 (see FIG. 9) between the ED 110m and the RAN node 170 may, if implemented as a wireless radio transmission, be vulnerable to a malicious attack. For example, when an inference request is transmitted in a wireless transmission from the ED 110m to the computing system 600 that hosts DNN 650 via the RAN node 170 over the air interface 930, the air interface 930 may be eavesdropped on or intercepted. Furthermore, the Type-I certification protocol performed by the RAN node 170 cannot provide confidence that an input data vector Xₘ* (742), generated by the reshaper 712 from the input data Xₘ (704, has not been tampered with or even replaced.

For example, consider an inference request that includes input data vector Xₘ (742) that is representative of an image that is used for object detection by the DNN 650, which has been trained to perform object detection on images. Such an inference request may be generated by an application running on an ED 110 that is a self-driving car and sent by the ED 110 via the communication system 100 to the computing system 600. A hacker may tamper with the input data vector Xₘ*(742) to form a tampered input data vector \tilde{X}*. An inference response that includes an inference data vector \tilde{Y}* generated by the DNN 650 based on the input data X obtained from the tampered input data vector \tilde{X} may be received, at the ED 110, indirectly from the computing system 600 that hosts the DNN 650. The inference data vector \tilde{Y}* may be subject to the certification protocol described hereinbefore, with reference to FIGS. 8, 11 and 12, between the RAN node 170 and the computing system 600. It is expected that the inference data vector \tilde{Y}* would be certified because \tilde{Y}=F(\tilde{X}), so that appropriate mutual information would be found.

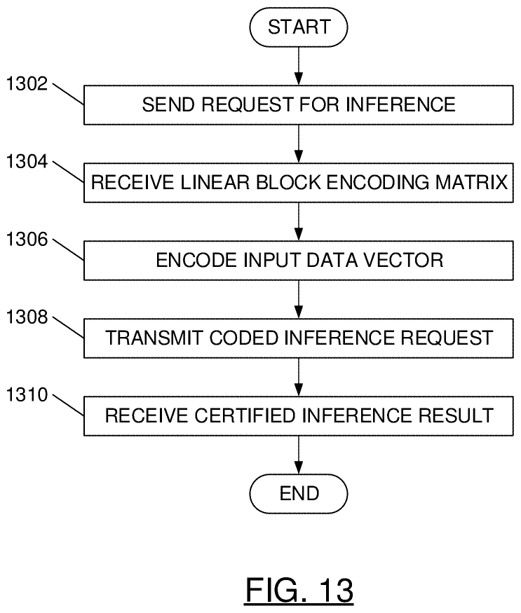

FIG. 13 illustrates example steps in a method of obtaining certified inference responses from the perspective of the ED 110m. FIG. 14 illustrates example steps in a method of handling an inference request from the perspective of the RAN node 170.

To protect against a malicious attack (eavesdropping and/or tampering) on an inference request contained in a wireless transmission 601 over the air interface 630, aspects of the present application relate to enabling the trustworthiness-specific encoder 714, at an ED 110, to encode an input data vector Xₘ* (742) using a linear block encoding matrix, such as the linear block encoding matrix, Uᵤₛₑᵣ, defined hereinbefore. Preferably, the dimensions, l_{Z}>l_{X}, of the linear block encoding matrix Uᵤₛₑᵣ may be selected so that some redundancy is added by the encoding. Moreover, the linear block encoding matrix Uᵤₛₑᵣ may be selected, with care by the computing system that hosts the DNN 650, to be a l_{Z}×l_{X} unitary matrix such that I=Uᵤₛₑᵣ⁻¹·Uᵤₛₑᵣ.

In preparation for operation, the ED 110m sends a request for inference for the DNN 650 (step 1302) to the computing system 600 that hosts the DNN 650, see FIG. 13. Responsive to the sending the request for inference, the ED 110m receives (step 1304), from the computing system 600 that hosts the DNN 650, a linear block encoding matrix Uₘ. Responsive to the request for inference for the DNN 650 from the ED 110m, the RAN node 170 receives (step 1402), from the computing system 600 that hosts the DNN 650, parameters for the reverse certification DNN (G(·; θₘ*)) and the linear block encoding matrix, Uₘ.

Instead of transmitting input data vector Xₘ* (742) in an inference request, the ED 110m first uses the trustworthiness-specific encoder 714 to encode (step 1306) the input data vector Xₘ* (742) to generate an encoded input vector Zₘ (744), where Zₘ*=Uₘ·Xₘ*. The ED 110m may then transmit (step 1308), to the RAN node 170, in a transmission 901, a coded inference request that includes the encoded input vector Zₘ (744).

Upon receiving (step 1404) the coded inference request, the RAN node 170 may make a local copy of the encoded input vector Zₘ (744) and decode (step 1406) the encoded input vector Zₘ (744) to obtain the input data vector Xₘ* (742). The decoding may be accomplished using the inverse, Uₘ⁻¹, of the linear block encoding matrix, Xₘ*=Uₘ⁻¹·Zₘ. In coding theory, if the linear block encoding matrix Uₘ, is unknown to a hacker, then the linear block encoding matrix presents substantial difficulty for the hacker to attack the encoded input vector Zₘ (744), especially in a real time. Furthermore, the more redundancy (l_{Z}−l_{X}) that is added, the more difficulty is presented to a potential hacker.

The RAN node 170 transmits (step 1408) an inference request to the computing system that hosts the DNN 650, F(·) in a transmission 602 as described above. The inference request includes, inter alia, the input data vector 742 (i.e. Xₘ*).

Upon receiving (step 1202, see FIG. 12), from the computing system 600 that hosts the DNN 650, a transmission 903 that contains an inference response that includes the encoded inference data vector W (844), the RAN node 170 decodes the encoded inference data vector W (844) using the trustworthiness decoder xxx to obtain inference data vector Y* (842). The RAN node 170 inputs the inference data vector Y* (842) into the reverse certification DNN (G(·; θₘ*)) to obtain (step 1204) an estimated encoded input data vector Zₘ′ (744), where Zₘ′=G(Y; θₘ*). The RAN node 170 then determines (step 1206) a square error ∥Zₘ′−Zₘ∥². Upon determining (step 1208) that the square error is less than a pre-defined threshold T₁, that is, determining (step 1208) that ∥Zₘ′−Zₘ∥²<T₁, then the RAN node 170 may consider that the inference data vector Y* (842), is a certified inference data vector Yₘ, that is, Yₘ=Y*. Accordingly, the RAN node 170 may transmit (step 1210), to the ED 110m, a certified inference response in a transmission 904 as described above. The certified inference response includes the certified inference data vector Yₘ. The ED 110m receives (step 1006, FIG. 10) the certified inference response.

Upon determining (step 1208) that the square error is greater than a pre-defined threshold, that is, upon determining (step 1208) that ∥Zₘ′−Zₘ∥²>T₁, the RAN node 170 may consider that the inference data vector (842), is not certified and the RAN node 170 may take no further action. Alternatively, the RAN node 170 may transmit (step 1212), to the ED 110m, an indication that the inference data vector Y could not be certified.

When l_{Z}>l_{X}, the generic linear block encoding matrix, Uᵤₛₑᵣ, is similar to a famous linear block code, known by the acronym “LDPC,” which stands for Low Dense Parity Check, which deals with a binary vector. In contrast, the linear block encoding matrix Uᵤₛₑᵣ, deals with a non-binary or a binary input data vector Xₘ. In a LDPC, the linear block encoding matrix, Uᵤₛₑᵣ, represents a check parity matrix with a redundancy of l_{Z}−l_{X}. Despite a non-binary input data vector Xₘ, LDPC code theory still holds.

Given l_{Z} and l_{X} (code length l_{X} and code rate l_{X}/l_{Z}), LDPC has a great number of check matrices. This means that there is no scarcity for a computing system that hosts the DNN 650 to choose a linear block encoding matrix Uᵤₛₑᵣ.

The check matrix of LDPC can be generated by some rules. Rather than sending a complete l_{Z}×l_{X} matrix, the computing system 600 that hosts the DNN 650 may simply send information to the EDs 110 and RAN nodes 170 about some rules for generation of user-tokens and dimensions (l_{X} and l_{Z}), which may be shown to not only greatly reduce the amount of information transmitted for a linear block encoding matrix Uᵤₛₑᵣ, but may also be shown to improve security.

A check matrix may be designed in a manner that makes an encoded input vector Zᵤₛₑᵣ, robust against hostile (e.g. random erased and noised) radio channels. Even if several elements of the encoded input vector Zᵤₛₑᵣ, are lost (or attacked), the RAN node 170 could still decode (step 1406) the encoded input vector Zᵤₛₑᵣ, to obtain the input data vector Xᵤₛₑᵣ*.

Upon receiving the encoded input vector Zᵤₛₑᵣ, across a hostile radio channel, the RAN node 170 may use some mature decoding algorithms, Belief Propagation or Message-passing, rather than the most naïve decoding algorithm, Xₘ*=Uₘ⁻¹·Zₘ, discussed hereinbefore.

In optional aspects of the present application, provided that the ED 110m has sufficient computation power, the ED 110m can carry out Type-I certifying using the reverse certification DNN (G(·; θₘ*)). That is, upon receiving (step 1202), from the computing system 600 that hosts the DNN 650, an inference response that includes an inference data vector 842 (i.e. Y*), the RAN node 170 may transmit a wireless transmission 905 containing an inference response which includes the inference data vector Y* (842) to the ED 110m. The ED 110m would then be responsible for inputting the inference data vector Y* (842), into the reverse certification DNN (G(·; θₘ*)) to obtain (in a step analogous to step 1204) an estimated encoded input data vector Zₘ′, where Zₘ′=G(Y*; θₘ*). The ED 110m may then determine (in a step analogous to step 1206) a square error ∥Zₘ′−Zₘ∥².

According to empirical observations, if the DNN 650 (F(·)) has in the order of billions of neurons, the corresponding reverse certification DNN (G(·; θₘ*)) may be expected to have at least in the order of millions of neurons. Carrying out computations of the reverse certification DNN (G(·; θₘ*)) may be shown to present computation challenges when the ED 110m is asked to obtain (in a step analogous to step 1204) an estimated encoded input data vector Zₘ′, where Zₘ′=G(Y; θₘ*). These challenges may be seen as particularly acute when the ED 110m is a low-cost and low-energy IOT device.

The Type-I certification protocol discussed hereinbefore leaves the transmission (step 1112, FIG. 11, step 1408, FIG. 14, core network transmission 902, FIG. 7A) of an input data vector Xₘ* (742) un-coded within the core network 130, which, as discussed, may include the Internet 150.

It follows that the RAN node 170 has awareness of each input data vector Xₘ* (742), and the corresponding inference data vector Y* (842). If the RAN node 170 is hacked, the hackers, or some other third party, could accumulate a number of input data vectors Xₘ* (742) and inference data vectors Y* (842). The hacker, or third party, may include the input data vector Xₘ* (742) and the inference data vector Y* (842) in a training dataset. The hacker, or third party, may then train a new DNN using the training dataset, thereby, “stealing” the DNN 650 (F(·)).

To inhibit this type of attack, aspects of the present application relate to not informing the RAN node 170 of the linear block encoding matrix Uₘ. Without awareness of the linear block encoding matrix Uₘ, the RAN node 170 will be unable to carry out step 1406 of the method of FIG. 14. That is, the RAN node 170 will be unable to obtain the input data vector Xₘ (742) based on a received coded inference request. The ED 110m transmits (step 1308, FIG. 13), to the RAN node 170, the coded inference request, which includes the encoded input vector Zₘ. The RAN node 170 simply relays the coded inference request to the DNN 650. A decoder (not shown) may be implemented at the entrance of the DNN 650 to obtain the input data vector Xₘ=Uₘ⁻¹·Zₘ. Notably, it may be shown to be unnecessary for the RAN node 170 to obtain the input data vector Xₘ, to perform a Type-I certification using the reverse certification DNN, G(·; θₘ*). This due to the RAN node 170 determining (step 1206) the square error, ∥Zₘ′−Zₘ∥² on the Z domain rather than on the X domain. The arrangement in which the RAN node 170 is not informed of the linear block encoding matrix, Uₘ, may be shown to make it impossible for a theoretical hacker in control of a hacked RAN node 170 to reverse-engineer the DNN 650, F(·). Indeed, the theoretical hacker may only obtain access to a set of inference data vectors Y.

Operation of the ED 110m in this scheme is consistent with operation of the ED 110m in the previous scheme, illustrated in FIG. 13. In preparation for operation, the ED 110m sends (step 1302), a request to the computing system that hosts the DNN 650, for the DNN 650 to perform inference. Responsive to the initialization, the ED 110m receives (step 1304), from the computing system that hosts the DNN 650, a linear block encoding matrix Uₘ.

Instead of transmitting input data vector Xₘ* (742) in an inference request, the ED 110m first uses the trustworthiness-specific encoder 714 to encode (step 1306) the input data vector Xₘ* (742) to generate an encoded input vector Zₘ (744), where Zₘ=Uₘ·Xₘ. The ED 110m may then transmit (step 1308), to the RAN node 170, a coded inference request that includes the encoded input vector Zₘ (744).

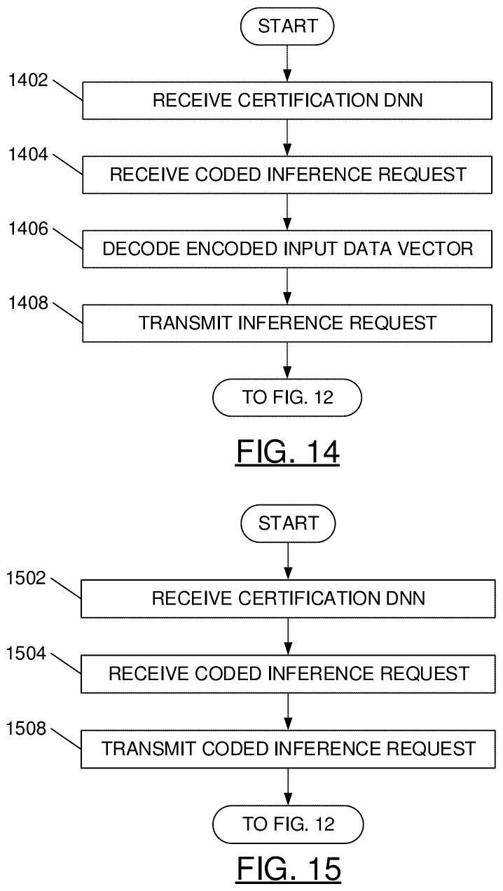

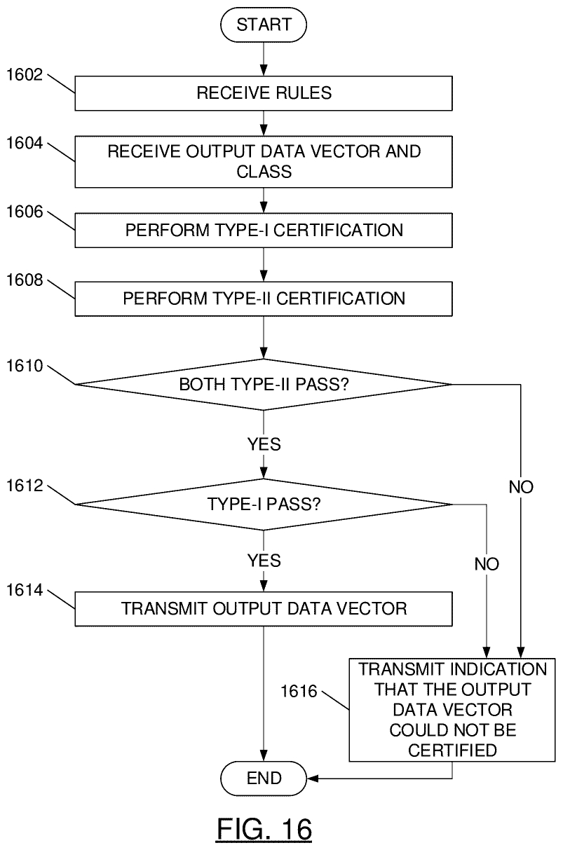

FIG. 15 illustrates example steps in a method of handling an inference request from the perspective of the RAN node 170 that is not provided access to the linear block encoding matrix, Uₘ. Responsive to the initialization (step 1302) of the inference service by the ED 110m, the RAN node 170 receives (step 1502) the reverse certification DNN, G(·; θₘ*). In contrast to step 1402 of FIG. 14, the RAN node 170, in this case, does not receive the linear block encoding matrix, Uₘ. Upon receiving (step 1504), from the ED 110m, the coded inference request, the RAN node 170 may transmit (step 1508) the coded inference request to the DNN-on-Cloud 650, which is arranged to implement the non-linear function, F(·). The inference request includes the encoded input vector 744, Zₘ. The RAN node 170 also makes a local copy of the encoded input vector 744, Zₘ.

As discussed hereinbefore, the computing system 600 includes a decoder (not shown) that is utilized to obtain the input data vector 742 (i.e. Xₘ=Uₘ⁻¹·Z_{m*}) from the encoded input data vector ( ). The computing system 600 may then obtain t inference data vector 842, Y, on the basis of the input data vector 742, Xₘ.

Upon receiving (step 1202, see FIG. 12), from the computing system 600 that hosts the DNN 650 a transmission 903 that contains an inference response that includes the inference data vector 842 (i.e.), the RAN node 170 inputs the inference data vector 842, Y, into the reverse certification DNN (G(·; θₘ*)), to obtain (step 1204) an estimated encoded input data vector Zₘ′, where Zₘ′=G(Y; θₘ*). The RAN node 170 then determines (step 1206) a square error ∥Zₘ′−Zₘ∥². Upon determining (step 1208) that the square error is less than a pre-defined threshold T₁, that is, determining (step 1208) that ∥Zₘ′−Zₘ∥²<T₁, then the RAN node 170 may consider that the inference data vector Y* (842) is a certified inference data vector Yₘ, that is, Yₘ=Y. Accordingly, the RAN node 170 may transmit (step 1210), to the ED 110m, a transmission 904 that contains a certified inference response. The certified inference response includes the certified inference data vector Yₘ. The ED 110m receives (step 1310, FIG. 13), from the RAN node 170, a transmission 904 that contains the certified inference response that includes the certified inference data vector Yₘ.

Upon determining (step 1208) that the square error is greater than a pre-defined threshold, that is, upon determining (step 1208) that ∥Zₘ′−Zₘ∥²>T₁, the RAN node 170 may consider that the inference data vector Y* (842) is not certified and the RAN node 170 may take no further action. Alternatively, the RAN node 170 may transmit (step 1212), to the ED 110m, an indication that the inference data vector Y* (842) could not be certified.

Up to this point, the certification protocols discussed may be shown to act to verify a returned inference response against Type-I malicious attacks and protect the transmissions of inference response vectors on both wireless and core network (Internet) connections. However, no certification methods have been built about the inference response vectors. This is addressed as follows.

A theoretical hacker may attack inference responses contained in the transmission 903 (see FIG. 9) from the computing system that hosts DNN 650 to the RAN node 170 in the following aspects.

In one aspect, the theoretical hacker may intercept an inference response vector and replace the intercepted inference response vector by a faked inference response vector. This aspect may be classified as a Type-I malicious attack. Accordingly, the Type-I certification protocols discussed hereinbefore may be used to check a faked output data vector in terms of mutual information between an input data vector and an output data vector.

In another aspect, the theoretical hacker may tamper with an inference data vector Y* (842), such that a small (but key) portion of the inference data vector 842 is changed. The tampered inference data vector may pass the Type-I certification test at the RAN node 170. Accordingly, a Type-II certification method may be implemented to detect the integrity of an inference data vector Y* (842) that is included inference response contained in a transmission 903 transmitted by the computing system 600 that hosts DNN 650.

Besides information theory, a DNN can be interpreted by topology theory. According to topology theory, some dominant topological patterns exist at the output of each layer of a DNN including at the output of the last layer. These dominant, hidden and persistent topological patterns may be compared to fingerprints and may be used when considering the integrity of an inference data vector Y* (842).

Aspects of the present application relate to a Type-II certification method that is based on topological patterns. The proposed Type-II certification method is intended to guard against Type-II malicious attacks, i.e., the method is intended to detect that a given output data vector has been tampered with. Similar to the Type-I certification, according to aspects of the present application, the RAN node 170 is arranged to carry out a Type-II certification on inference data vector Y* (842). It is expected that the computing system 600 that hosts the DNN 650 has awareness of persistent topological patterns present in the DNN 650, an organization that owns the computing system 600 that host the DNN 650 (otherwise referred to as a “provider” of the computing system) could design a linear encoding matrix V, (with l_{W}×l_{Y}, l_{W}>l_{Y}). The linear encoding matrix V, may be used to encode an inference data vector Y* (842) to provide an encoded inference data vector W (844), where W=V·Y*. The computing system 600 that hosts the DNN 650 provides the RAN node 170 of the linear encoding matrix V, along with some Type-II certification rules.

The rules and procedure include selecting and grouping certain dimensions of the encoded inference data vector W (844), which is a l_{W}×1 vector, into several groups. For example, a first group may include selected elements [w₁, w₃, w₇], a second group may include selected elements [w₃, w₅] and a third group may include selected elements [w₂, w₉].

The rules and procedure also include performing an intra-group consistence check to determine whether there is a strong consistence correlation among the elements in a group. For example, if w₁ is high valued, w₃ and w₇ must be high valued as well within the first group. If all the groups pass the intra-group consistence checking, the RAN node 170 would perform an inter-group consistence check.

The rules and procedure also include performing an inter-group consistence check to determine whether the distribution of average values of the elements of different groups is consistent with known persistent patterns. For example, in consideration of a known persistent pattern wherein, if the average value of the elements in the second group is high, then the average value of the elements in the third group is expected to be low. Any violation of the known persistent pattern would fail the inter-group consistence check.

If an inference data vector Y* (842) passes both intra-group and inter-group consistence checks, the RAN node 170 may determine that the inference data vector Y* (842), passes the Type-II certification. Note that, passing a Type-II certification is independent of passing a Type-I certification. For instance, consider a valid inference data vector Yₙ* determined at the computing system 600 that hosts the DNN 650 on the basis of an inference request received from ED 110n. In a case wherein the valid, but incorrect, inference data vector Yₙ*, is received at the ED 110m, the valid, but incorrect, inference data vector Yₙ* may pass the Type-II certification check but may not pass a Type-I certification described hereinbefore.

In some aspects of the present application, the RAN node 170 (in combination with the ED 110m and, if necessary, the computing system 600 that hosts the DNN 650 may implement only a version of Type-I certification discussed hereinbefore. In other aspects of the present application, the RAN node 170 may implement only Type-II certification, as discussed hereinbefore. In preferred aspects of the present application, the RAN node 170 may implement both a version of Type-I certification and Type-II certification.

The RAN node 170 may carry out the two types of certification in parallel or in sequence. From a latency point of view, a parallel approach is preferred. From an energy-saving point of view, a sequential approach is preferred. In preferred aspects of the present application, the RAN node 170 carries out the Type-II certification before carrying out the Type-I certification. The Type-I certification is expected to take more energy to input the inference data vector 842 (i.e., Y*), into the reverse certification DNN, G(·; θₘ*), to obtain (step 1204, FIG. 12) an estimated input data vector. If a given inference data vector Y* (842), fails to pass Type-II certification, it may be seen as unnecessary to attempt Type-I certification on the given inference data vector Y* (842).

A set of the Type-II certification rules may include a first rule, relating to the encoding matrix V_{c}: W=V_{c}·Y. A second of these rules relates to a grouping table G_{c}. The grouping table indicates the dimensions of the encoded inference data vector W (844) that are to be selected and indicates the groups into which the selected dimensions are to be grouped.

A third of these rules relates to intra-group reference distributions, correlation methods and thresholds. A reference distribution of an i^{th} group may be denoted Rᵢ. A received distribution of the i^{th} group may be denoted ry. A intra-group correlation function, corrᵢ(rᵢ, Rᵢ), may be used as a measure of similarity, γᵢ=corrᵢ(rᵢ, Rᵢ), between the received distribution, rᵢ, and the reference distribution, Rᵢ. There may be many choices for the intra-group correlation function, corrᵢ(rᵢ, Rᵢ), such as inner product and cosine distance. A threshold for the i^{th} group may be denoted Tᵢ.

A fourth of these rules relates to inter-group reference distribution, correlation method and threshold. A reference distribution of the averages of all the groups may be denoted R_{g}. Where there are L groups, the reference distribution of the averages may be determined as a vector with length, L, as follows:

$${R}_{g} = [ avg ( {R}_{1} ) , avg ( {R}_{2} ) , … , avg ( {R}_{L} ) ]$$

A received distribution of the averages of all the groups may be denoted r_{g}. Where there are L groups, the received distribution of the averages may be determined as a vector with length, L, as follows:

$${r}_{g} = [ avg ( {r}_{1} ) , av g ( {r}_{2} ) , … , avg ( {r}_{L} ) ]$$

An inter-group correlation function, corr_{g} (r_{g}, R_{g}), may be used as a measure of similarity, γ_{g}=corr_{g}(r_{g}, R_{g}), between the received distribution, r_{g}, and the reference distribution, R_{g}. There may be many choices for the inter-group correlation function, corr_{g} (r_{g}, R_{g}), such as inner product and cosine distance. A threshold for the groups may be denoted T_{g}.

A set of the Type-II certification rules may be given to the RAN node 170 in terms of a class of an inference data vector Y* (842). In practice, the computing system that hosts the DNN 650 would inform the RAN node 170 of several Type-II certification rules. The indicator of the inference types may be provided, to the RAN node 170, in conjunction with the provision of an inference data vector Y* (842). The RAN node 170 may choose the set of Type-II certification rules on the basis of the indicator and then may certify the inference data vector Y* (842) using the chosen set of Type-II certification rules.

An overview of certification is illustrated as example steps in a method in FIG. 16. The certification begins with the RAN node 170 receiving (step 1602), from the computing system 600 that hosts the DNN 650, a plurality of sets of Type-II certification rules. Indeed, each set of Type-II certification rules may be associated with a result class c. Optionally, the computing system that hosts the 650 may provide only one set of Type-II certification rules. Receipt (step 1604), at the RAN node 170, of an inference data vector Y* (842), is associated with receipt, from the computing system that hosts the DNN 650, of an indicator of the result class c. The RAN node 170 may proceed to perform (step 1606) Type-I certification in one of the many ways described hereinbefore.

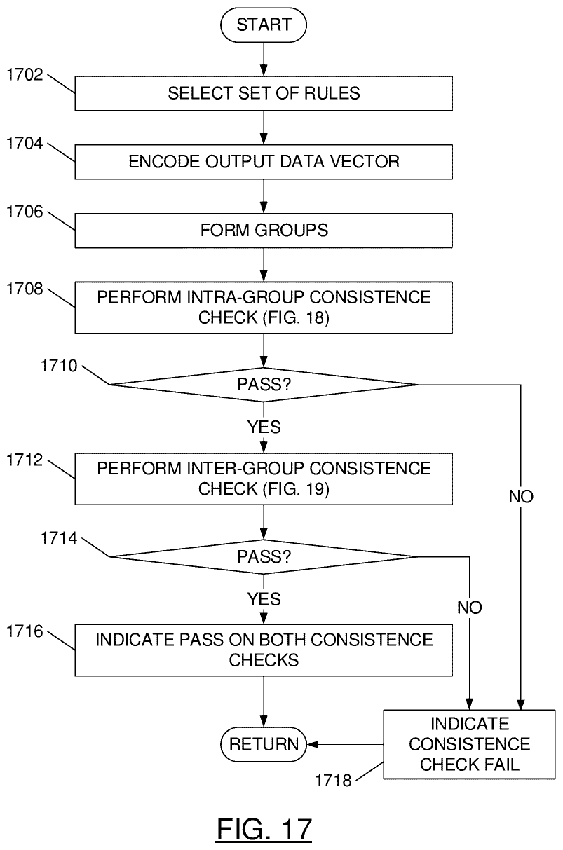

The RAN node 170 may proceed to perform (step 1608) Type-II certification in accordance with example steps in a method of carrying out a Type-II certification protocol, illustrated in FIG. 17.

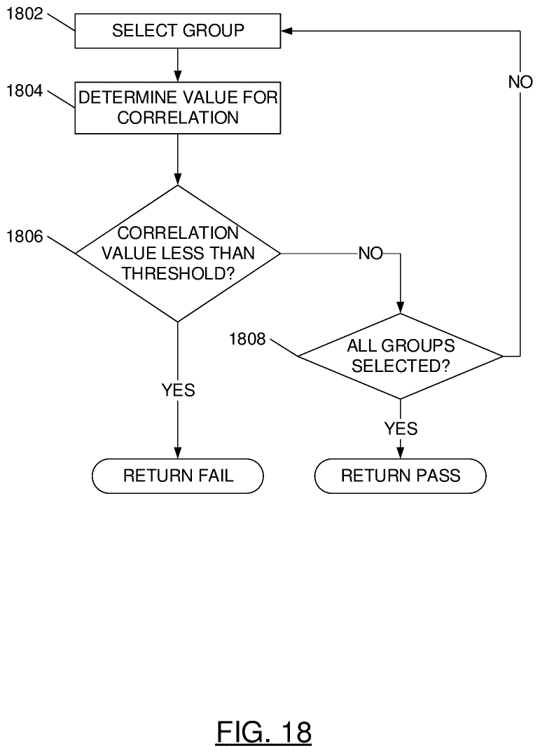

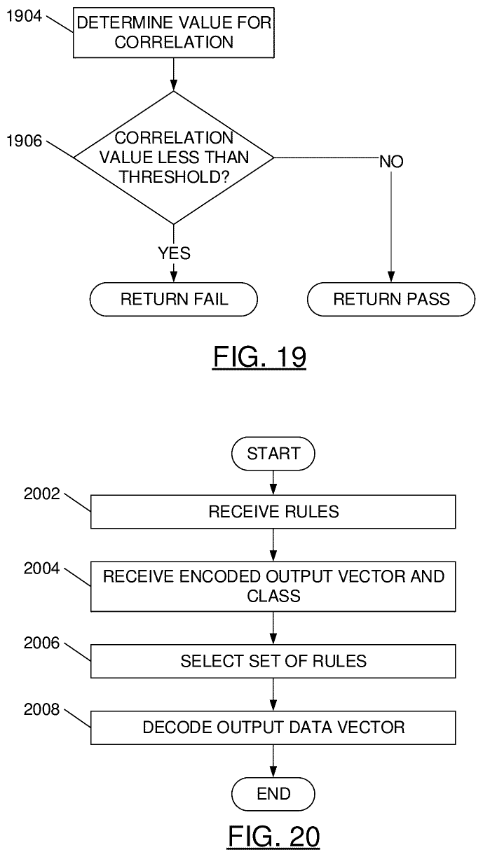

On the basis of the indicator of the class c, for the inference data vector Y* (842) received in step 1604, the RAN node 170 may select (step 1702) a set of Type-II certification rules from the RAN node memory 258 (see FIG. 3). Notably, if the RAN node only received (step 1602) a single set of Type-II certification rules, the selection (step 1702) may be skipped. The RAN node 170 may then proceed to use the encoding matrix V_{c}, from the selected set of Type-II certification rules, to encode (step 1704) the inference data vector Y* (842) into an encoded output vector W (844), where W=V_{c}·Y. The RAN node 170 may then use the grouping table G_{c} from the selected set of Type-II certification rules, to form (step 1706) groups from the encoded output vector W (844). The RAN node 170 may then perform (step 1708) an intra-group consistence check (FIG. 18) and may also perform (step 1712) an inter-group consistence check (FIG. 19).

Example steps of a method of performing (step 1708) an intra-group consistence check are illustrated in FIG. 18. The intra-group consistence check involves determining whether the value of an intra-group correlation function, determined for each group, surpasses the corresponding intra-group threshold for all the groups.

In FIG. 18, the RAN node 170 selects (step 1802) a group i, and determines (step 1804) a value γᵢ=corrᵢ(rᵢ, Rᵢ), for the intra-group correlation function for the selected group. The RAN node 170 compares (step 1806) the value γᵢ, for the intra-group correlation function against an appropriate threshold Tᵢ. Upon determining (step 1806) that the value for the intra-group correlation function is greater than or equal to the threshold, the RAN node 170 determines (step 1808) whether all groups have been selected. Upon determining (step 1808) that not all groups have been selected, the RAN node 170 selects (step 1802) a further group and the process of determining (step 1804) and comparing (step 1806) repeats for the further group. Upon determining (step 1806) that the value for the intra-group correlation function is less than the threshold, the RAN node 170 may indicate that the inference data vector γ* (842) has failed the intra-group consistence check and, accordingly, has failed the Type-II certification.

Upon determining (step 1806) that the value of the intra-group correlation function surpasses the corresponding threshold for all the groups, the RAN node 170 may indicate that the inference data vector Y* (842) has passed the intra-group consistence check.

Returning to FIG. 17, upon determining (step 1710) that the inference data vector Y* (842) has failed the intra-group consistence check, the RAN node 170 may indicate (step 1718) that the inference data vector Y* (842) has failed a consistence check. Upon determining (step 1710) that the inference data vector Y* (842) has passed the intra-group consistence check, the RAN node 170 may proceed to perform (step 1712) an inter-group consistence check.

Example steps of a method of performing (step 1712) an inter-group consistence check are illustrated in FIG. 19. The inter-group consistence check involves determining whether the value of an inter-group correlation function surpasses a threshold.

In FIG. 19, the RAN node 170 determines (step 1904) a value γ_{g}=corr_{g} (r_{g}, R_{g}), for the inter-group correlation function. The RAN node 170 then compares (step 1906) the value γ_{g} for the inter-group correlation function against the inter-group threshold T_{g}. Upon determining (step 1906) that the value γ_{g} for the inter-group correlation function is less than the inter-group threshold T_{g}, the RAN node 170 may indicate that the inference data vector Y* (842) has failed the inter-group consistence check and, accordingly, has failed the Type-II certification. Upon determining (step 1906) that the value γ_{g} of the inter-group correlation function for all the groups surpasses the inter-group group threshold T_{g}, the RAN node 170 may indicate that the inference data vector Y* (842) has passed the inter-group consistence check.

Returning to FIG. 17, upon determining (step 1714) that the inference data vector Y* (842) has failed the inter-group consistence check, the RAN node 170 may indicate (step 1718) that the inference data vector Y* (842) has failed a consistence check. Upon determining (step 1714) that the inference data vector Y* (842), has passed the inter-group consistence check, the RAN node 170 may proceed to indicate (step 1716) that the inference data vector Y* (842) has passed both consistence checks.

Returning to FIG. 16, upon determining (step 1610) that the inference data vector Y* (842) has passed both the intra-group consistence check and the inter-group consistence check and upon determining (step 1612) that the inference data vector Y* (842) has passed Type-I certification, the RAN node 170 may transmit (step 1614) the inference data vector Y* (842), to the ED 110m with an indication that the inference data vector Y* (842) has passed two types of certification. Upon determining (step 1610) that the inference data vector Y* (842) has failed a consistence check, the RAN node 170 may transmit (step 1616) an indication that the inference data vector Y* (842) could not be certified. Upon determining (step 1612) that the inference data vector Y* (842) has failed Type-I certification, the RAN node 170 may transmit (step 1616) an indication that the inference data vector Y* (842) could not be certified.

In aspects of the present application, the RAN node 170 may determine (step 1804) the L different intra-group correlation values (γ₁, γ₂, . . . , γ_{L}), and determine (step 1904) the all-groups correlation value γ_{g}, without comparing (step 1806, step 1906) the correlation values against a corresponding threshold. Instead, the RAN node 170 may transmit (step 1614) the correlation values to the ED 110m along with the inference data vector Y* (842), such that it is left as an exercise for the ED 110m to compare the correlation values against a corresponding threshold.

Notably, the intra-group consistence check (step 1708) is illustrated, in FIG. 17, as occurring before the inter-group consistence check (step 1712). It should be clear to a person of ordinary skill in the art that the order of these two checks is immaterial to the result. Indeed, it may be shown to be more practical to carry out these two checks in parallel. Such a parallel approach may be seen as well-suited to implementation on a computing system that includes processor(s) having many cores, such as a GPU.

It has been discussed hereinbefore that a theoretical hacker may attack inference data vector Y* (842) contained in the transmission 903 (see FIG. 9) from the computing system 600 that hosts DNN 650 to the RAN node 170. Similarly, it is contemplated that a theoretical hacker may attack inference data vector Y* (842) contained in the transmission 904 (see FIG. 9) from the RAN node 170 to the ED 110m. Indeed, even after confirming, at the RAN node 170, Type-II certification of an inference data vector Y* (842) received from the computing system 600 that hosts the DNN 650, the theoretical hacker may tamper with, or otherwise alter, inference data vector Y* (842) contained in a transmission 904 that is transmitted over the air interface 630 (see FIG. 9) from the RAN node 170 to the ED 110m.

In operation, as part of the Type-II certification method discussed in conjunction with FIG. 17, it has been discussed that the RAN node 170 may use the encoding matrix V_{c}, from the selected (step 1702) set of Type-II certification rules, to encode (step 1704) an inference data vector Y* (842) that has been received in step 1604 (FIG. 16) into an encoded inference data vector W (844), where W=V_{c}·Y.

According to aspects of the present application, upon determining (step 1610, step 1612) that the received inference data vector 842 has been certified (both Type-I and Type-II), the encoded inference vector W (844) may be considered to be an encoded certified vector Wₘ, where Wₘ=V_{c}·Yₘ*. Notably, it is expected that V_{c} (l_{W}×l_{Y}, l_{W}>l_{Y}) is a unitary matrix (I=V_{c}⁻¹·V_{c}).

In FIG. 16, the RAN node 170 transmits (step 1614) the inference data vector Y* (842) to the ED 110m with an indication that the inference data vector Y* (842) has passed two types of certification. In aspects of the present application directed to maintaining the privacy of the certified inference data vector Yₘ*, the RAN node 170 may, instead, transmit the encoded certified inference data vector Wₘ (844) to the ED 110m along with an indication of the result class c.

FIG. 20 illustrates example steps in a method of receiving the certified encoded inference vector Yₘ*. At the time of providing rules to the RAN node 170, the DNN 650 may also provide the plurality of sets of Type-II certification rules to the ED 110m. Again, each set of rules may be associated with a result class, c.

The method of FIG. 20 begins with the ED 110m receiving (step 2002), from the DNN 650, the plurality of sets of Type-II certification rules. The ED 110m may, subsequently, receive (step 2004), from the RAN node 170, the certified encoded output vector Wₘ and an indication of the result class c. The ED 110m may select (step 2006) a set of Type-II certification rules on the basis of the result class c. As mentioned hereinbefore, there may be only one set, in which case the selecting step is obviated. The ED 110m may then obtain (step 2008) a decoded certified inference data vector Yₘ*, where Yₘ*=V_{c}⁻¹·Wₘ. In those situations wherein the decoding matrix V_{c}⁻¹, is known only to the ED 110m, it may be understood that the privacy of decoded certified inference data vector Yₘ*, is protected. Furthermore, because the encoding matrix V_{c}, is a linear block encoding matrix, use of the decoding matrix V_{c}⁻¹, at the ED 110m, may be considered to be a relatively naïve decoding strategy. It should be clear that some more complicated, but more effective, decoding strategies may be available as alternatives. For example, a belief-propagation algorithm and message-passing algorithm can each be used as a decoding strategy. These decoding strategies can allow some dimension loss during the transmission 904 (FIG. 9) from the RAN node 170 to the ED 110m.

In some aspects of the present application, wherein the ED 110m has sufficient computing power, the ED 110m may receive (step 2004) the encoded inference vector (844) and result class, c, and, upon decoding the inference data vector (842), the ED 110m may carry out the example Type-II certification method steps illustrated in FIGS. 17, 18 and 19.

Rather than performing, at the RAN node 170, the encoding (step 1704) of an output data vector 842, Y, into an encoded output vector 844, W=V_{c}·Y, aspects of the present application relate to performing, at the DNN 650, the encoding of an output data vector 842, Yₘ, into an encoded output vector 844, Wₘ=V_{c}·Yₘ. The DNN 650 may then be expected to send, to the RAN node 170, the encoded output vector 844, Wₘ.

Upon receipt of the encoded inference vector Wₘ (844) the RAN node 170 may decode the encoded inference vector Wₘ (844) to obtain the inference data vector (844), where Yₘ=V_{c}⁻¹·Wₘ. The RAN node 170 may then attempt to certify the output data vector 842 using methods discussed hereinbefore.

Upon determining that the inference data vector (842), has been certified, the RAN node 170 may transmit the inference data vector Yₘ (842) to the ED 110m as described with reference to step 1614 of FIG. 16. Alternatively, the RAN node 170 may transmit the encoded inference data vector Wₘ (844) as received by the RAN node 170 from the DNN 650.

Because the encoding matrix, V_{c}, is a linear block encoding matrix, use of the decoding matrix, V_{c}⁻¹, at the RAN node 170, to obtain decoded certified inference data vector Yₘ=V_{c}⁻¹·Wₘ, may be considered to be a relatively naïve decoding strategy. It should be clear that some more complicated, but more effective, decoding strategies may be available as alternatives. For example, a belief-propagation algorithm and message-passing algorithm can each be used as a decoding strategy. These decoding strategies can allow some dimension loss during the transmission 903 (FIG. 9) from the computing system 600 that hosts the DNN 650 to the RAN node 170.

An administrator of the computing system 600 that hosts the DNN 650 may be concerned that the RAN node 170, when equipped with the encoding matrix, V_{c}, has an ability to obtain the inference data vector Yₘ (842). This arrangement allows the RAN node 170 to carry out the Type-I certification methods described hereinbefore. In theory, because the encoding matrix, V_{c} (l_{W}×l_{Y}), is a linear expansion (l_{W}≥l_{Y}), it may be expected that no information about the inference data Y will be lost and/or distorted. Therefore, the inputting, by the RAN node 170, of the inference data vector 842 (i.e. inference data vector Y), into the reverse certification DNN, G (·; θₘ*), to obtain (step 1204) an estimated encoded input data vector Zₘ′, where Zₘ′=G(Y; θₘ*), in the Type-I certification could be changed or trained so that the encoded inference data vector Wₘ (844) is acceptable input. The RAN node 170 may, under these changes, input the encoded inference data vector Wₘ (844) to obtain an estimated encoded input data vector Zₘ′, where Zₘ′=G_{c}(Wₘ; θₘ*). Note that the Type-II certification involves a consideration of the result class, c, so the reverse certification DNN (G_{c}(·; θₘ*)) is specific to the result class, c.

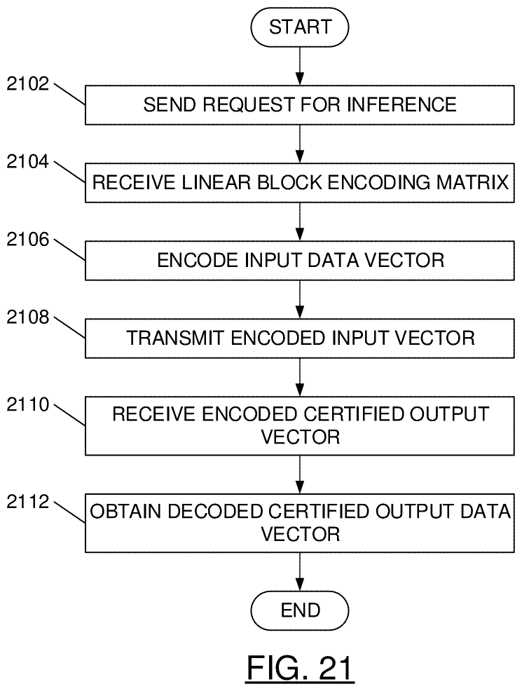

FIG. 21 illustrate example steps in a method associated with encoded input vectors 744 and encoded output vectors 844.

The ED 110m sends a request for the DNN 650 to perform inference to the computing system 600 that hosts the DNN 650 (step 2102, see FIG. 21). In the request, the ED 110m may specify a single result class, c, or a plurality of result classes. In response to the request, the ED 110m receives (step 2104), from the computing system 600 that hosts DNN 650, an ED-specific encoding matrix, Uₘ, and a class-specific encoding matrix, V_{c}. The computing system 600 that hosts DNN 650 may provide an encoding matrix, V_{c}, for each of the result classes specified in the request.

Responsive to receiving the request to perform inference, the computing system 600 that hosts the DNN 650 may provide, to the RAN node 170, parameters for a class-specific reverse certification DNN (G_{c}(·; θₘ*)). The computing system 600 that hosts the DNN 650 may provide parameters for each of the specified result classes.

The computing system 600 that hosts DNN 650 may also provide, to the RAN node 170, a set of Type-II certification rules. Recall that Type-II certification rules include a grouping table G_{c}, a number, L, of intra-group reference distributions, Rᵢ, L intra-group correlation functions, corrᵢ(·, Rᵢ), L intra-group thresholds, Tᵢ, an inter-group reference distribution, R_{g}, an inter-group correlation function, corr_{g}(·, R_{g}) and an inter-group threshold, T_{g}.

In operation, the trustworthiness-specific encoder 714 of the ED 110m encodes (step 2106) an input data vector Xₘ* (742) to generate an encoded input vector Zₘ (744), where Zₘ=Uₘ·Xₘ*. The ED 110m transmits (step 2108), to the RAN node 170, an inference request, which includes the encoded input vector Zₘ (744).

The RAN node 170 may simply relay the inference request to the computing system 600 that hosts the DNN 650. The RAN node 170 may save the encoded input vector Zₘ (744), in memory 258 of the RAN node 170. A trustworthiness decoder (not shown) at the computing system 600 (or the DNN 650) obtains the input data vector Xₘ* (742), where Xₘ*=Uₘ⁻¹·Zₘ) and a reshaper 752 that performs the inverse operations of the at the computing system 600 obtains the input data Xₘ as described above.

The DNN 650 performs inference, on the basis of the input vector Xₘ (704) to generate inference data 804. The DNN 650 then generates the inference response that includes the inference data 804 and outputs the inference data. The computing system 600 then reshapes, using reshaper encodes the inference data vector Yₘ (842) into an encoded inference data vector Wₘ (844), where Wₘ=V_{c}·Yₘ. The computing system 600 that hosts the DNN 650 may then transmit, to the RAN node 170, a transmission 904 that contains the inference response that includes, inter alia, the encoded output vector 844 (i.e. Wₘ).

Upon receiving the transmission 903 containing the inference response that includes the encoded inference vector 844 (i.e., Wₘ), and in view of previously having received, and stored, the encoded input vector Zₘ (744), and class-specific reverser certification DNN, G_{c}(·; θₘ*), the RAN node 170 may carry out Type-I certification and Type-II certification in a manner consistent with the discussion, hereinbefore, of the method of FIG. 16.

Upon determining that the encoded inference data vector Wₘ (844) has been certified, the RAN node 170 may transmit an inference response that includes the encoded inference data vector 844 (i.e. inference data vector Wₘ), to the ED 110m as described with reference to step 1614 of FIG. 16.

Upon receiving (step 2110) the encoded certified vector 844, Wₘ, the ED 110m may obtain (step 2112) a certified inference data vector 842, Yₘ, where Yₘ=V_{c}⁻¹·Wₘ as described above.

Conveniently, this latter method may be seen to provide full protection to an inference request for DNN 650. First of all, all the transmissions 901, 902, 903, 904 (FIG. 9) are coded. Second of all, the RAN node 170 is configured to certify the encoded inference data vector 844 included in the inference response received from the computing system 600 that hosts the DNN 650. Third of all, a theoretical hacker has no way of accumulating input data vectors 742 (or input data 704) and corresponding inference data vectors 842 (or inference data 804) that can be used to train a malicious or new DNN.

A theoretical hacker could hack into a RAN node 170 and accumulate encoded input data vectors 744 (i.e. Zₘ) and encoded output inference data vectors 844 (i.e. Wₘ). The theoretical hacker may even use the accumulated encoded input data vectors 744 (i.e. Zₘ) and the encoded inference data vectors 844 (i.e. Wₘ) to train a counterfeit DNN. However, from the foregoing, it may be noted that the encoded input data vectors 744 (i.e. Zₘ) and the encoded inference data vectors 844 (i.e. Wₘ) are generated based on the encoding matrices Uₘ and V_{c}. Periodically, the DNN 650 may change the encoding matrices Uₘ and V_{c}. It should be clear that such a change would immediately invalidate the counterfeit DNN.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

1. A method performed at an electronic device, the method comprising:
generating an inference request for a deep neural network (DNN), the inference request comprising input data for the DNN;
encoding, using a linear block encoder, an input data vector obtained based on the input data to generate an encoded input vector;
transmitting the inference request to a computing system that hosts the DNN, the inference request including the encoded input vector; and
receiving an inference response from the computing system hosting the DNN, the inference response comprising a certified inference data vector generated by the DNN based on the input data.

2. The method of claim 1, further comprising:
transmitting a request to initialize coded transmission for inference.

3. The method of claim 2, further comprising:
receiving, responsive to the transmitting the request to initialize the coded transmission for inference, a linear block encoding matrix.

4. The method of claim 2, further comprising:
receiving, responsive to the transmitting the request to initialize the coded transmission for inference, an inferred data vector decoding matrix.

5. The method of claim 1, wherein the inference response includes an encoded output data vector, and the method further comprises:
decoding, using an output data vector decoding matrix, the encoded output data vector to obtain a decoded output data vector.

6. A method performed by a radio access network (RAN) node, the method comprising:
receiving an inference request for a deep neural network (DNN) from an electronic device, the inference request including an input data vector;
transmitting the inference request to a computing system that hosts the DNN;
encoding, using a linear block encoder, the input data vector to obtain an actual encoded input vector;
receiving an inference response from the computing system, the inference response including an output data vector generated by the DNN based on the input data vector;
obtaining, based on the output data vector, an estimated encoded input vector;
obtaining a trustworthiness score representative of a comparison between the estimated encoded input vector and the actual encoded input vector; and
responsive to determining that the trustworthiness score exceeds a threshold, transmitting the output data vector to the electronic device.

7. The method of claim 6, wherein the trustworthiness score comprises a squared difference between the estimated encoded input vector and the actual encoded input vector.

8. The method of claim 6, wherein the transmitting the inference request comprises:
transmitting the inference request to an inference neural network, wherein the inference neural network is configured to approximate a non-linear function.

9. The method of claim 8, wherein the obtaining the estimated encoded input vector comprises:
providing the output data vector to a certification neural network, where the certification neural network has been trained to output the estimated encoded input vector responsive to receiving the output data vector received as output of the non-linear function.

10. The method of claim 9, further comprising:
receiving, from a provider of the inference neural network, a linear block encoding matrix.

11. An apparatus comprising:
at least one processor coupled with a non-transitory computer-readable medium storing instructions, when the instructions executed by a computer, cause the apparatus to perform operations including:
generating an inference request for a deep neural network (DNN), the inference request comprising input data for the DNN;
encoding, using a linear block encoder, an input data vector obtained based on the input data to generate an encoded input vector;
transmitting the inference request to a computing system that hosts the DNN, the inference request including the encoded input vector; and
receiving an inference response from the computing system hosting the DNN, the inference response comprising a certified inference data vector generated by the DNN based on the input data obtained.

12. The apparatus of claim 11, the operations further comprising:
transmitting a request to initialize coded transmission for inference.

13. The apparatus of claim 12, the operations comprising:
receiving, responsive to the transmitting the request to initialize the coded transmission for inference, a linear block encoding matrix.

14. The apparatus of claim 12, the operations further comprising:
receiving, responsive to the transmitting the request to initialize the coded transmission for inference, an inferred data vector decoding matrix.

15. The apparatus of claim 11, wherein the inference response includes an encoded output data vector, and the operations further comprise:
decoding, using an output data vector decoding matrix, the encoded output data vector to obtain a decoded output data vector.

16. An apparatus comprising:
at least one processor coupled with a non-transitory computer-readable medium storing instructions, when the instructions executed by a computer, cause the apparatus to perform operations including:
receiving an inference request for a deep neural network (DNN) from an electronic device, the inference request including an input data vector;
transmitting the inference request to a computing system that hosts the DNN;
encoding, using a linear block encoder, the input data vector to obtain an actual encoded input vector;
receiving an inference response from the computing system, the inference response including an output data vector generated by the DNN based on the input data vector;
obtaining, based on the output data vector, an estimated encoded input vector;
obtaining a trustworthiness score representative of a comparison between the estimated encoded input vector and the actual encoded input vector; and
responsive to determining that the trustworthiness score exceeds a threshold, transmitting the output data vector to the electronic device.

17. The apparatus of claim 16, wherein the trustworthiness score comprises a squared difference between the estimated encoded input vector and the actual encoded input vector.

18. The apparatus of claim 16, wherein the transmitting the inference request comprises:
transmitting the inference request to an inference neural network, wherein the inference neural network is configured to approximate a non-linear function.

19. The apparatus of claim 18, wherein the obtaining the estimated encoded input vector comprises:
providing the output data vector to a certification neural network, where the certification neural network has been trained to output the estimated encoded input vector responsive to receiving the output data vector received as output of the non-linear function.

20. The apparatus of claim 19, the operations further comprising:
receiving, from a provider of the inference neural network, a linear block encoding matrix.
